(19) United States
(12) Patent Application Publication
(10) Pub. No.: US 2025/0174067 A1
(43) Pub. Date: May 29, 2025

(54) MONEY ITEM HANDLING APPARATUS AND METHODS

(71) Applicant: Crane Payment Innovations Limited, Royton, Oldham (GB)

(72) Inventors: Kevin Mulvey, Warrington (GB); David Taylor, Bolton (GB); Wladislaw Merems, Stade (DE)

(21) Appl. No.: 18/842,789

(22) PCT Filed: Feb. 27, 2023
(86) PCT No.: PCT/GB2023/050436

§ 371 Date: Aug. 29, 2024

(30) Foreign Application Priority Data
Mar. 3, 2022 (GB) 2202943.3

(51) Int. Cl. G07D 9/00

(52) U.S. Cl. CPC G07D 9/008

(57) ABSTRACT

A money item handling apparatus including a money item detection apparatus. The money item detection apparatus is operable in a system comprising a money item conveyor. The money item detection apparatus comprises a contact region arranged to physically interact with money items in a disruption configuration on the money item conveyor, and a trigger region physically connected to the contact region and moveable between first and second positions. A physical interaction between the contact region and a money item in a disruption configuration on the money item conveyor causes the trigger region to move from the first position to the second position to halt the money item conveyor.

### CROSS REFERENCE TO RELATED APPLICATIONS

This application is a 371 National Stage of International Application No. PCT/GB2023/050436, filed Feb. 27, 2023, which claims priority to United Kingdom Patent Application No. GB 2202943.3, filed Mar. 3, 2022, the disclosures of which are herein incorporated by reference.

### TECHNICAL FIELD

This specification relates to methods and apparatuses for handling money items.

### BACKGROUND

Money item handling systems can be used to receive, process, store and/or dispense money items. In such systems, money items may be conveyed internally between different regions, for example in order to move money items from a storage region to a dispensing region or to sort money items into different groups.

### SUMMARY

This specification provides a money item conveying apparatus, comprising: a first track section comprising at least one first money item conveying element; a second track section comprising at least one second money item conveying element; and a static support section located between the first track section and the second track section; wherein the first track section and the second track section are configured to move together relative to the static support section to convey a primary money item in contact with the at least one first money item conveying element and the at least one second money item conveying element over the static support section.

The at least one first money item conveying element and the at least one second money item conveying element may be configured to stably locate the primary money item in a centre-justified position over the static support section during movement of the first and second track sections.

The at least one first money item conveying element and the at least one second money item conveying element may be configured to stably locate the primary money item in a position which at least partially overlaps the static support section, the first track section and the second track section.

The money item conveying apparatus may further comprise at least one money item sensor located at least partially within the static support section.

The static support section may comprise at least one aperture in which the at least one money item sensor is at least partially located.

The at least one money item sensor may be configured to determine physical and/or geometric characteristics of the primary money item.

The at least one money item sensor may be configured to determine electromagnetic characteristics of the primary money item.

The static support section may comprise a first mating region arranged to cooperate with a corresponding mating region of the first track section; and the static support section may comprise a second mating region arranged to cooperate with a corresponding mating region of the second track section.

The static support section may comprise a surplus money item ejection portion which is configured to direct a surplus money item away from the static support section and off the money item conveying apparatus.

The surplus money item ejection portion may comprise a recessed region of the static support section into which the surplus money item is conveyed to be directed off the money item conveying apparatus.

The surplus money item may be conveyed into the recessed region of the static support section by at least partial abutment between a rearward edge of the surplus money item and a forward edge of the primary money item as the first and second track sections move together relative to the static support section.

The surplus money item may be located directly forward of the primary money item in a direction of movement of the first and second track sections.

The surplus money item ejection portion may be arranged to physically interact with the surplus money item to direct the surplus money item off the conveying apparatus.

The surplus money item ejection portion may comprise an ejection element which traverses a width of the static support section at a non-perpendicular angle relative to a direction of movement of the first and second track sections.

Surplus money items may be forced against the ejection element by forward movement of the first and second track sections.

At least partial abutment between a rearward edge of the surplus money item and a forward edge of the primary money item may push the surplus money item against the ejection element.

The first and second track sections may be arranged to support the primary money item away from the surplus money item ejection portion of the static support.

The first and second track sections may each comprise: a money item support surface for supporting a principal face of the primary money item away from the surplus money item ejection portion of the static support; and a recessed surface; wherein the money item support surface and the recessed surface of each of the first and second track sections are separated by a transition ramp.

A distance between the transition ramp of the first track section and the transition ramp of the second track section may increase with increasing distance from the at least one first conveying element and the at least one second conveying element.

This specification also provides a money item detection apparatus operable in a system comprising a money item conveyor, wherein the money item detection apparatus comprises: a contact region arranged to physically interact with money items in a disruption configuration on the money item conveyor; and a trigger region physically connected to the contact region and moveable between first and second positions; wherein physical interaction between the contact region and a money item in a disruption configuration on the money item conveyor causes the trigger region to move from the first position to the second position to halt the money item conveyor.

The trigger region may be configured to actuate a switch when moved to the second position to prevent further motion of the money item conveyor.

Actuation of the switch may cause a drive apparatus which is engaged with the money item conveyor to cease actuating the money item conveyor.

The switch may comprise an optical link which is broken by an opaque portion of the trigger region when the trigger region moves into the second position.

The contact region and the trigger region may be coupled to a pivot.

The physical interaction between the contact region and the money item in the disruption configuration may cause the trigger region to move around the pivot into the second position.

The contact region may be coupled to a first pivot and the trigger region may be coupled to a second pivot.

The physical interaction between the contact region and the money item in the disruption configuration may cause the contact region to move around the first pivot and the trigger region to move around the second pivot into the second position.

The contact region may comprise a contact element which extends towards the money item in the disruption configuration as the money item approaches the detection apparatus on the money item conveyor.

A leading edge of the contact element may curve directly away from a principal surface of the money item conveyor to physically interact with the money item in the disruption configuration.

A leading edge of the contact element may be angled directly away from a principal surface of the money item conveyor to physically interact with the money item in the disruption configuration.

A conveyor-side of the contact element may comprise at least one channel for accommodating an upstanding element of the money item conveyor as the upstanding element passes the contact element.

The money item in the disruption configuration may be at least partially balanced on an upstanding element of the money item conveyor.

The trigger region may naturally adopt the first position when not physically interacting with the money item in the disruption configuration.

Example implementations are described below with reference to the accompanying figures.

### BRIEF DESCRIPTION OF THE DRAWINGS

FIG. 1 is an illustration of aspects of a money item handling system including a money item conveying apparatus.

FIG. 2A is a plan view of a section of a money item conveyor, in which a primary money item is located in a stable configuration on first and second tracks separated by an elongated support.

FIG. 2B is a perspective view of a section of a money item conveyor, in which a primary money item is located in a stable configuration on first and second tracks separated by an elongated support.

FIG. 3 is a side-on, cut-away view of a section of a money item conveyor, in which a primary money item is located over an elongated support in which a money item sensor is arranged to sense characteristics of the primary money item as it is conveyed over the support.

FIG. 4 is a perspective, cut-away view of a section of a money item conveyor, in which a primary money item is located over an elongated support in which a money item sensor is arranged to sense characteristics of the primary money item as it is conveyed over the support.

FIG. 5 is a side-on, cut-away view of a section of a money item conveyor, in which a primary money item is located directly over a money item sensor arranged in an elongated support.

FIG. 6 is an end-on, cut-away view of a money item conveyor in which first and second tracks are mechanically engaged with an elongated support positioned between the tracks.

FIG. 7 is an end-on view of a section of a track of a money item conveyor. A guide region of the track is arranged to engage with a corresponding guide region of an adjacent support.

FIG. 8 is a perspective view of a section of a track of a money item conveyor. A guide region of the track is arranged to engage with a corresponding guide region of an adjacent support.

FIG. 9 is an illustration of a drive side of a track of a money item conveyor. The drive side is configured to engage with a drive apparatus to drive motion of the track around a path of the conveyor.

FIG. 10 is an illustration of a drive side of each of a pair of tracks of a money item conveyor. The drive sides of the tracks are configured to engage with a drive apparatus to drive motion of the tracks around a path of the conveyor.

FIG. 11 is a perspective illustration of a drive apparatus for driving first and second tracks of a money item conveyor around a path of the conveyor.

FIG. 12 is a first view of an installation of a drive apparatus in a money item handling system. The drive apparatus is engaged with first and second tracks of a money item conveyor.

FIG. 13 is a second view of an installation of a drive apparatus in a money item handling system. The drive apparatus is engaged with first and second tracks of a money item conveyor.

FIG. 14 is an illustration showing the outlines of a set of differently sized primary money items accommodated in a stable configuration on a section of a money item conveyor. Also shown is the outline of a surplus money item positioned in another region of the section of the conveyor.

FIG. 15 is a top-down illustration of recessed regions and money item support regions on a money item conveying side of first and second tracks.

FIG. 16 is a perspective illustration of recessed regions and money item support regions on a money item conveying side of first and second tracks.

FIG. 17 is a perspective illustration of a primary money item and a surplus money item on a conveyor. The surplus money item is located in a recessed region of the conveyor forward of the primary money item.

FIG. 18 is a perspective illustration of money items in a primary configuration and an ejection configuration on a conveyor.

FIG. 19 is a perspective illustration of money items in a primary configuration and an ejection configuration on a conveyor, where the money item in the ejection configuration is interacting with an ejection element of the conveyor.

FIG. 20 is a plan view of money items in a primary configuration and an ejection configuration on a conveyor, where the money item in the ejection configuration is interacting with an ejection element of the conveyor during a first stage of ejection.

FIG. 21 is a plan view of money items in a primary configuration and an ejection configuration on a conveyor, where the money item in the ejection configuration is interacting with an ejection element of the conveyor during a second stage of ejection.

FIG. 22 is a perspective view of an ejection region of a money item conveyor, in which an angled ejection element is arranged to interact with surplus money items in an ejection configuration to eject them from the conveyor.

FIG. 23 is a plan view of an ejection region of a money item conveyor, in which an angled ejection element is arranged to interact with surplus money items in an ejection configuration to eject the money items from the conveyor.

FIG. 24 is a perspective illustration of an ejection region of a money item conveyor and transition regions of a surface of a support between tracks of the conveyor.

FIG. 25 is a flow diagram of a method of singulating money items on a conveyor.

FIG. 26 is a perspective illustration of an apparatus configured to detect money items which are undesirably positioned on a conveyor and to prevent such money items from causing operational disruption to the conveyor.

FIG. 27 is a perspective illustration of a money item contact element of an apparatus configured to detect money items which are undesirably positioned on a conveyor.

FIG. 28 is a side-on illustration of a section of a conveyor and an apparatus configured to detect money items which are undesirably positioned on the conveyor.

FIG. 29 is a side-on illustration of a section of a conveyor and a detection apparatus which is detecting a money item undesirably positioned on the conveyor by physically interacting with the money item.

FIG. 30 is a perspective illustration of a money item detection apparatus configured to detect money items which are undesirably positioned on a conveyor and to prevent such money items from causing operational disruption to the conveyor.

FIG. 31 is a side-on illustration of a section of a conveyor and a money item detection apparatus configured to detect money items which are undesirably positioned on the conveyor.

FIG. 32 is a further side-on illustration of a section of a conveyor and a money item detection apparatus configured to detect money items which are undesirably positioned on the conveyor.

FIG. 33 is a cut-away illustration of first and second money item sensors positioned either side of a money item conveyor in a sensing region of the conveyor path.

FIG. 34 is a perspective illustration of an apparatus, shown in a first state, which is configured to detect money items which are undesirably positioned on a conveyor and to prevent such money items from causing operational disruption to the conveyor.

FIG. 35 is a perspective illustration of an apparatus, shown in a second state, configured to detect money items which are undesirably positioned on a conveyor and to prevent such money items from causing operational disruption to the conveyor.

FIG. 36 is a schematic diagram of elements of a money item handling system.

### DETAILED DESCRIPTION

A money item handling system comprising various different aspects and having a corresponding plurality of functions is described below. The money item handling system includes at least one conveying apparatus which is configured to convey money items, such as coins, between different regions of the system. Aspects of the conveying apparatus have the capability to convey money items proximally to one or more money item sensors so that characteristics of the money items can be accurately and reliably sensed by the sensors as the money items are conveyed between the different regions of the system. Further aspects of the system have the capability to prevent money items from becoming jammed on the conveying apparatus and, in so doing, to reduce the likelihood of operational disruption and/or damage to the system during conveyance of money items between the different regions of the system.

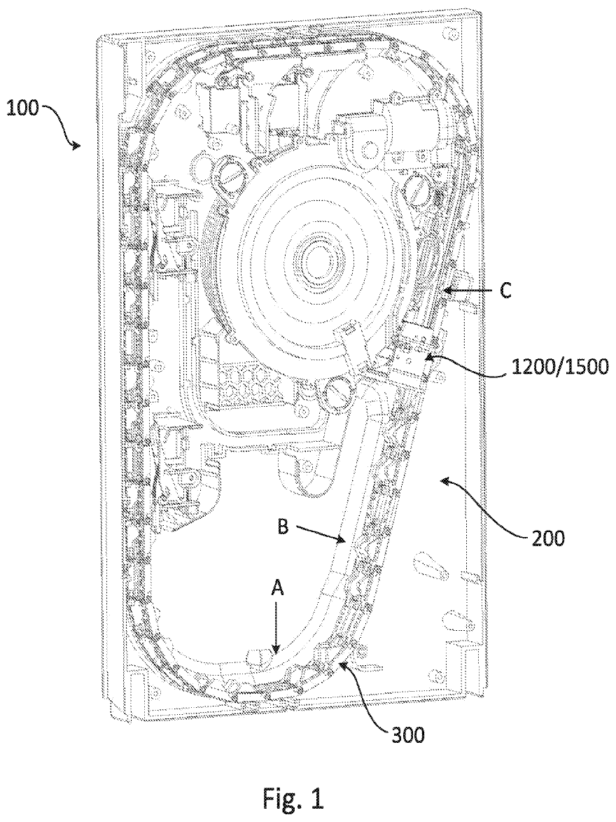

FIG. 1 illustrates an example of a money item handling apparatus 100 comprising a money item conveying apparatus 200. In the illustrated example, the money item conveying apparatus 200 comprises an endless loop conveyor 300 which is arranged to convey money items along an inclined region of the conveyor 300 from a lower region of the conveyor 300 to an upper region of the conveyor 300. As discussed further below, the money item conveying apparatus 200 also comprises a drive apparatus which is configured to drive movement of the conveyor 300 around its conveying path so as to convey money items between the different regions of the system 100.

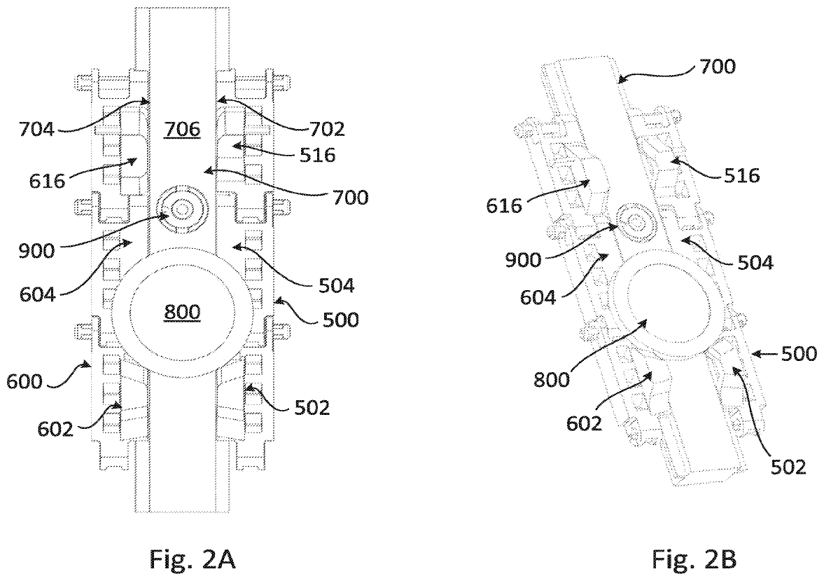

As shown by the conveyor section illustrated in FIGS. 2A and 2B, the conveyor 300 comprises a first track 500 and a second track 600 which extends parallel to the first track 500. The conveyor 300 also comprises an elongated support 700. The support 700 is located between the first and second tracks 500, 600 so that the first and second tracks 500, 600 are separated from one another by the support 700. As will be described in greater detail below, the first and second tracks 500, 600 are configured to move in unison relative to the support 700, which remains static, in order to convey money items along the path of the conveyor 300.

In FIGS. 2A and 2B, the support 700 has first and second longitudinal edges 702, 704 which extend in the same direction as the conveyor path and are substantially parallel with one another. The first track 500 is arranged adjacent to a first side of the support 700 against the first longitudinal edge 702, while the second track 600 is arranged adjacent to a second side of the support 700 against the second longitudinal edge 704. The first and second tracks 500, 600 extend along the corresponding edges 702, 704 of the static support 700 so that they may run parallel to the elongated support 700 along the path of the conveyor 300. Close correspondence between the edges 702, 704 of the support 700 and the tracks 500, 600, as illustrated in FIGS. 2A and 2B, may be aided by mating regions of the tracks 500, 600 and the support 700. The mating regions contribute to stable alignment between the tracks 500, 600 and the support 700 during operation of the conveyor 300, as discussed in more detail below with respect to FIG. 6.

As can be seen from FIGS. 2A and 2B, each section of the first track 500 comprises a first money item conveying element 502 which is upstanding from a money item support surface 504 on a money item conveying side of the first track 500. Likewise, each section of the second track 600 comprises a second money item conveying element 602 which is upstanding from a money item support surface 604 on a money item conveying side of the second track 600. Each pair of conveying elements 502, 602 are configured to abut an edge of a primary money item 800 whose main face is lying against the money item support surfaces 504, 604 in a manner which spans the elongated support 700 between the first and second tracks 500, 600. The contact between the edge of the primary money item 800 and the first and second conveying elements 502, 602 centre-justifies the primary money item 800 between the first and second tracks 500, 600 in a primary configuration, so that the main face of the money item 800 remains positioned directly over the support 700. In this respect, as best shown in FIG. 2A, a centre of the primary money item may directly overlie a longitudinal centreline of the support 700. In the primary configuration, the money item 800 is supported in a stable position over the static support 700 and may be conveyed forward, in this position, in a highly predictable manner relative to the support 700.

One or more money item sensors 900, which are configured to sense physical and/or electromagnetic characteristics of money items, are located proximally to the path of the conveyor 300. For example, referring again to the section of conveyor 300 illustrated in FIGS. 2A and 2B, one or more money item sensors 900 may be located at least partially in the support 700 so that a main face of the primary money item 800 passes directly over the sensor(s) 900 as the money item 800 is conveyed forward by the first and second tracks 500, 600. The one or more sensors 900 may be embedded in the support 700. As the primary money item 800 is conveyed over the sensor(s) 900 in its stable configuration between the tracks 500, 600, the position of the main face of the primary money item 800 relative to the money item sensor(s) 900 in the support 700 is highly predictable. This allows the sensor(s) 900 to be configured to obtain very accurate and reliable measurements of the characteristics of primary money items 800 passing over the sensor(s) 900 on the conveyor tracks 500, 600. The distance between the money items 800 and the sensor(s) 900 may be as little as the distance between the surface 706 of the support 700 and the main face of the money items 800 facing the support 700.

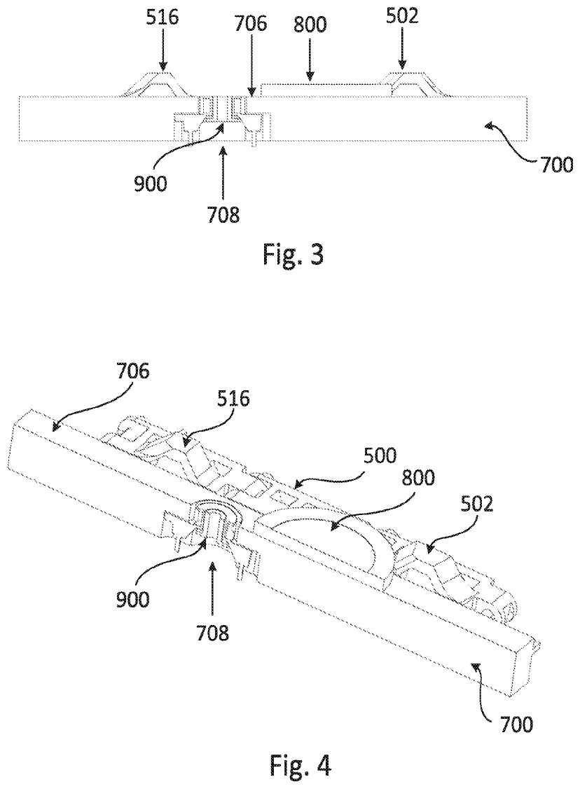

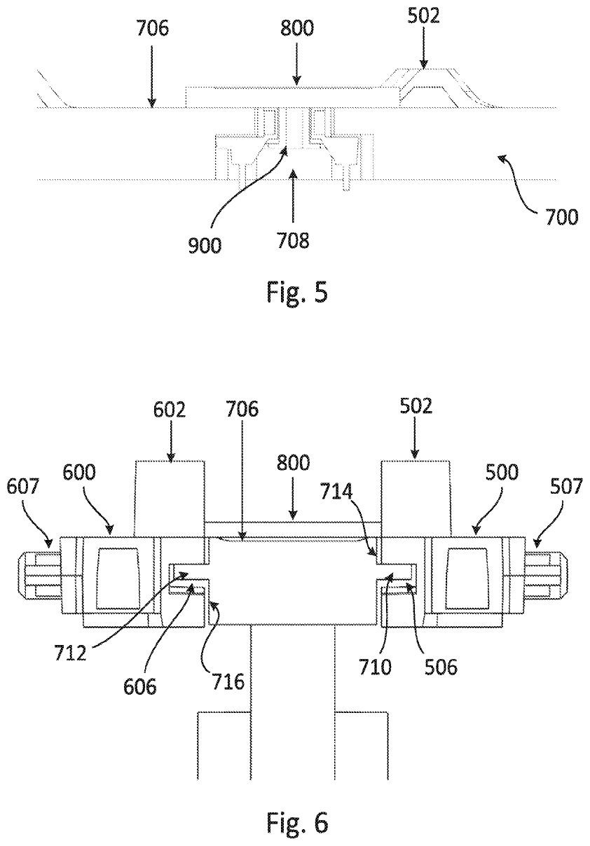

An arrangement of a sensor 900 inside the elongated support 700 is illustrated in FIGS. 3, 4 and 5. In FIGS. 3-5, the second track 600 is omitted from the illustrations to better show the location of the sensor 900 in the support 700. It can be seen from these figures that the support 700 comprises an aperture 708 in which the sensor 900 is accommodated. The aperture 708 allows the sensor 900 to be embedded or otherwise installed in the support 700 so that the sensor 900 can reliably sense characteristics of money items on the conveyor 300 in the manner described above. The sensor 900 may be fixedly embedded in the support 700 to a degree which means that the upper part of the sensor 900 is aligned with, or close to being aligned with, the surface 706 of the support 700. For example, as shown in FIG. 3, the upper part of the sensor 900 may be flush, or substantially flush, with the surface 706 closest to the money items 800 on the tracks 500, 600. In this regard, it may be that the upper surface of the sensor 900 is located just subsurface of the surface 706 of the support 700. These arrangements allow the main face of a money item 800 to travel directly over and along the support 700 in very close proximity to the sensor 900, as shown in FIG. 5, without passage of the money item 800 being interrupted or otherwise disrupted by the sensor 900 during sensing operations. Additionally, the arrangements ensure that the sensor 900 remains protected. The sensor 900 may be any type of sensor configured to sense electromagnetic, geometric or other physical characteristics of the money item 800. Further discussion of possible sensors is included further below.

The reliability and accuracy of measurements obtained from the sensor(s) 900 is further assisted by mechanical engagement between the support 700 and the first and second tracks 500, 600. Mechanical engagement between these different elements of the conveyor 300 avoids or reduces any potential for undesirable oscillatory movement of the first and/or second tracks 500, 600 relative to each other and the plane of the support 700. Furthermore, mechanical engagement between the support 700 and the first and second tracks 500, 600 helps to maintain a desired geometrical relationship between the money item support surfaces 504, 604 of the tracks 500, 600 and the surface 706 of the static support 700 in different regions of the conveyor path. For example, as discussed in more detail below, the engagement between the different elements of the conveyor may maintain a consistent distance between the sensor(s) 900 in the support 700 and primary money items 800 passing over the sensor(s) 900 on the conveyor tracks 500, 600. This may be advantageous in at least two respects. Firstly, when measuring characteristics of a particular money item 800 passing over the sensor(s) 900, a consistent distance between the main face of the money item 800 and the sensor(s) 900 in the support 700 improves the consistency of sensing conditions for that particular money item 800. Secondly, providing substantially the same sensing conditions for each of many different money items 800 passing over the sensor(s) 900, for example as a series of money items following one another on the conveying tracks 500, 600, may help to increase the reliability of comparisons between measurements of the different money items and/or may permit still further fining tuning of the sensor(s) 900 to optimally sense particular characteristics of those money items under the consistent sensing conditions created by the arrangement of the conveyor 300.

Referring to FIG. 6, the support 700 comprises mating regions 710, 712 which are arranged to cooperate with corresponding mating regions 506, 606 on the first and second tracks 500, 600. In the example illustrated in FIG. 6, a first mating region 710 on the first side of the support 700 is configured to engage with a corresponding first mating region 506 on the first track 500. Additionally, a second mating region 712 on the second side of the support 700 is configured to engage with a corresponding second mating region 606 on the second track 600. As mentioned above, the mechanical engagement between the mating regions 710, 712 of the support 700 and the mating regions 506, 606 of the tracks 500, 600 prevents or significantly reduces the potential for the first and/or second tracks 500, 600 to oscillate relative to the static support 700, and retains a desired geometrical relationship between the money item support surfaces 504, 604 of the tracks 500, 600 and the surface 706 of the static support 700 in different regions of the conveyor path. As described in detail below, the first and second tracks 500, 600 are maintained in broad alignment with the support 700 so that primary money items 800 in the stable configuration described above progress forwards and/or backwards on the conveyor 300 in a smooth and predictable manner relative to the upper surface 706 of the support 700.

As shown in FIG. 6, the first mating region 710 of the support 700 may comprise a first projection which extends outwardly from the first side of the support 700 towards the first track 500. Likewise, the second mating region 712 of the support 700 may comprise a second projection which extends outwardly from the second side of the support 700 towards the second track 500. The projections may extend at an angle which is substantially perpendicular with the respective side faces 714, 716 of the support 500.

Also as shown in FIG. 6, the first mating region 506 of the first track 500 may comprise an elongated accommodating region, such as a groove, which is configured to receive the projection of the first mating region 710 of the support 700. Likewise, the second mating region 606 of the second track 600 may comprise another elongated accommodating region, such as a further groove, which is configured to receive the projection of the second mating region 712 of the support 700. This engagement between the accommodating regions on the tracks 500, 600 and the projections on the first and second sides of the support 700 is retained as the tracks 500, 600 move forward/backward relative to the support 700. In this way, the first and second tracks 500, 600 are secured in broad alignment with the support 700.

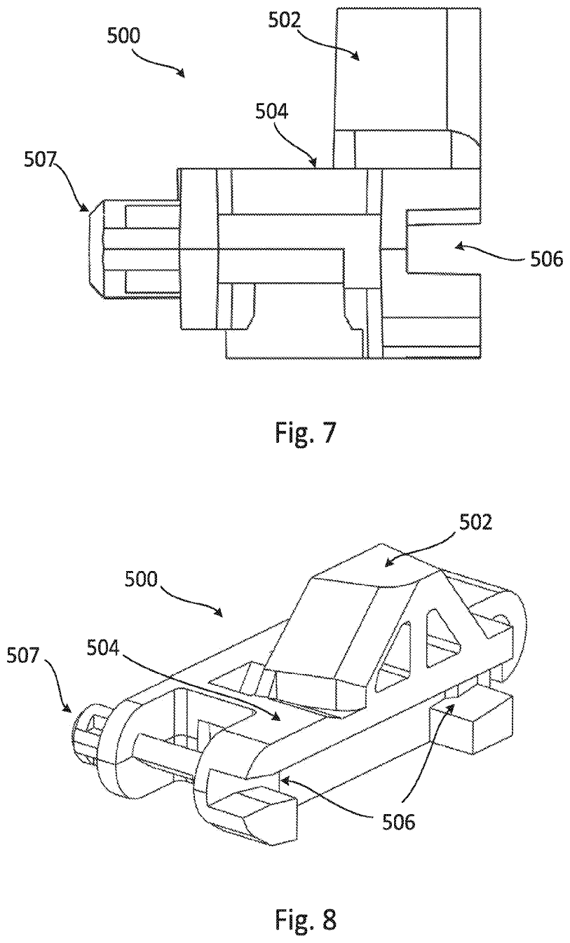

As an example of the details of the mating regions present on both tracks 500, 600, further views of the mating region 506 of the first track 500 are shown in FIGS. 7 and 8. In FIGS. 7 and 8, the mating region 506 of the first track 500 is illustrated in absence of the static support 700. Both figures show the groove of the mating region 506 and give additional context to the manner in which the projection from the first side of the support 700 is accommodated to create mechanical engagement between the first track 500 and the support 700. As will be discussed further below, in addition to the grooved accommodating region for engaging with the support 700, FIGS. 7 and 8 also illustrate the frontal region of the money item conveying element 502 of the first track 500. The arrangement and details shown with respect to the first track 500 in FIGS. 7 and 8 may be replicated for the second track 600 to create the engagement between the second track 600 and second side of the support 700 shown in FIG. 6. In this respect, it can be seen from many of the figures that, in addition to the mating regions 506, 606 discussed above which contribute to engagement between the inner edges of the tracks 500, 600 and the support 700, the first and second tracks 500, 600 also comprise additional elements 507, 607 which cooperate with a separate guide to stabilise the tracks 500, 600 on the their outer edges as they move around the conveyor path. For example, referring to FIGS. 6-13, each track section 500, 600 may comprise an additional support element 507, 607 in the form of one or more pips which engage or otherwise physically cooperate with a static guide (not shown) at the outer edge of each track 500, 600. In this respect, the static guide may comprise a first groove which extends along the outer edge of the first track 500 and a second groove which extends along the outer edge of the second track 600. The support elements 507, 607 at the outer edge of each track 500, 600 may engage with these grooves so that the outer edges of the tracks 500, 600 are supported during movement of the tracks around the conveyor path.

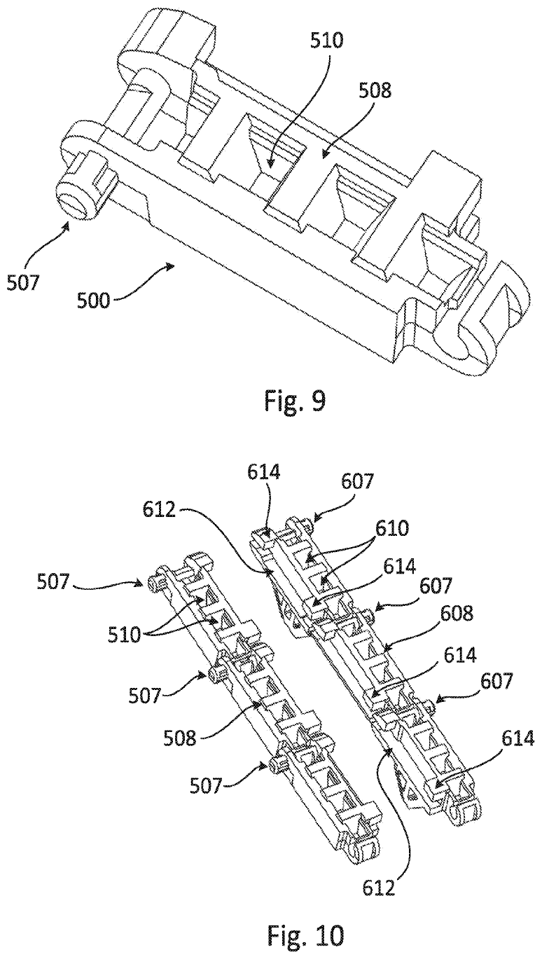

FIG. 9 illustrates a drive side 508 of the first track 500. The drive side 508 is opposite to the money item support surface 504 of the track 500 and is arranged to engage with the drive apparatus of the system 100 so that the track 500 can be selectively driven around the path of the conveyor 200. As shown in FIG. 9, the drive side 508 of the track 500 comprises an engagement region 510 in which a series of recesses, which could be described as a ‘rack’, are arranged lengthwise along the track 500. The engagement region 510 on the drive side 508 of the first track 500 is also shown in FIG. 10 alongside a corresponding engagement region 610 on a drive side 608 of the second track 600. As with the engagement region 510 on the drive side 508 of the first track 500, the engagement region 610 on the drive side 608 of the second track 600 comprises a series of recesses arranged lengthwise along the track 600.

In addition to the drive sides 508, 608 described above, FIG. 10 also shows another view of the mating regions 506, 606 of the first and second tracks 500, 600. As can be seen from FIG. 10, the grooves of the mating regions 506, 606 of tracks 500, 600 may be formed by rail elements. In particular, referring to the second track 600 as an example, a substantially continuous first rail element 612 may run lengthwise along the side of the track 600 at a location towards the money item support surface 604, and a plurality of shorter rail elements 614 may run lengthwise along the same side of the track 600 at a location towards the drive side 608. In this configuration, the first rail element 612 is parallel to the second rail elements 614 and the gap between the first and second rail elements 612, 614 forms the groove which accommodates the projection in the mating region 712 on the second side of the support 700. A corresponding arrangement is present on the first track 500. The support 700 is omitted from FIG. 10 for improved clarity around the shape and function of the tracks 500, 600.

Referring back to FIG. 1, the path of the conveyor 300 comprises a plurality of different regions in which the geometric relationship between the money item support surfaces 504, 604 of the tracks 500, 600 and the surface 706 of the static support 700 may be different. For example, in a substantially horizontal lowermost region A of the conveyor path, in which new money items 800 may be collected by the tracks 500, 600 from a pool of money items in a money item collection area of the system, the engagement between the tracks 500, 600 and the support 700 described above may be such that the surface 706 of the support 700 is below the money item support surfaces 504, 604 of the tracks 500, 600. This arrangement may maximise the ability of the upstanding conveying elements 502, 602 of the tracks 500, 600 to pick up new money items as the tracks 500, 600 move through the pool. Once collected, money items 800 in the primary configuration sit on the support surfaces 504, 604 of the tracks 500, 600, against the upstanding conveying elements 502, 602, and clear of the surface 706 of the support 700. In other words, in this lowermost region A of the conveyor path, primary money items 800 do not come into contact with the static support 700.

Following the lowermost region A, the conveyor 300 progresses to an inclined transit region B in which primary money items 800 in the stable, primary configuration described above with respect to FIGS. 2A and 2B are conveyed upwards towards a money item sensing region C of the conveyor path. In the inclined transit region B of the conveyor path, the relationship between the money item support surfaces 504, 604 of the tracks 500, 600 and the surface 706 of the static support 700 may be similar to (e.g. substantially the same as) the lowermost region A. In other words, in the inclined transit region B, primary money items 800 on the money item support surfaces 504, 604 of the tracks 500 may be supported away from the surface 706 of the static support 700. This ensures that the static support 700 does not impede or otherwise disrupt progress of the primary money items 800 (e.g. through frictional contact with the main faces of the money items 800) as the money items 800 are conveyed towards the sensor(s) 900 in the sensing region C of the conveyor path.

In the sensing region C, which as shown in FIG. 1 may be inclined in a manner similar to the preceding transit region B, the relationship between the money item support surfaces 504, 604 of the tracks 500, 600 and the surface 706 of the static support 700 may be different to that described above with respect to the first two regions A, B. In particular, rather than being supported on the money item support surfaces 504, 604 of the tracks 500, 600, in the sensing region C the main faces of primary money items 800 may lie directly against the surface 706 of the support 700. This ensures accuracy and consistency of measurements made by the sensor(s) 900, as discussed further above.

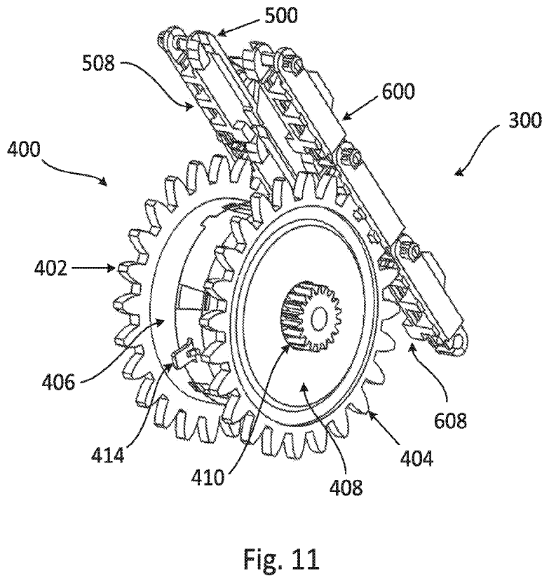

An example of the drive apparatus 400 of the conveying apparatus 200 is illustrated in FIG. 11. The drive apparatus 400 is controllable to selectively drive movement of the first and second tracks 500, 600 via continuous engagement between engagement regions 402, 404 of the drive apparatus 400 and the corresponding engagement regions 510, 610 on the drive sides 508, 608 of the tracks 500, 600. In particular, the drive apparatus 400 comprises a first engagement region 402 configured to engage with the engagement region 510 of the first track 500 and a second engagement region 404 configured to engage with the engagement region 610 of the second track 600. As shown in FIG. 11, each engagement region 402, 404 of the drive apparatus 400 may comprises a set of teeth which are arranged to engage with the series of recesses on the drive sides 508, 608 of the first and second tracks 500, 600. The teeth of the first engagement region 402 are arranged around the circumference of a first drive wheel 406, while the teeth of the second engagement region 404 are arranged around the circumference of a second drive wheel 408.

The drive apparatus 400 is configured to drive movement of the first and second tracks 500, 600 in unison, so that both tracks 500, 600 move at the same rate and in the same direction along the path of the conveyor 300. In the example drive apparatus 400 illustrated in FIG. 11, this is achieved by the first and second sets of teeth of the engagement regions 402, 404 having corresponding shapes and spacings, and by similar correspondence between the engagement regions 510, 610 of the tracks 500, 600.

The first and second drive wheels 406, 408 may each be coupled to, and centred on, a common drive axle 410 so that rotation of the drive axle 410, for example via a coupling between the axle 410 and an electrically driven actuator 412 (e.g. one or more electrical motors) causes the first and second tracks 500, 600 to be moved over the same distance at the same rate along the conveyor path. It will be appreciated that other arrangements of the drive apparatus 400 could equally be used to achieve unified movement of the first and second tracks 500, 600. For example, the drive apparatus 400 may alternatively comprise a planetary gearbox via which the first and second tracks 500, 600 are driven around the path of the conveyor 300.

As shown in FIG. 11, the drive apparatus 400 may comprise at least one physical projection or other element which is configured for use in synchronizing the first and second tracks 500, 600 during movement of the tracks 500, 600 around the path of the conveyor 300. The projection or other element(s) may take the form of one or more flags 414 which operate with sensors, such as optical sensors, so that rotation of the first and second drive wheels 406, 408 can be accurately tracked and used to derive how far the tracks 500, 600, and therefore any money items 800 upon them, have correspondingly progressed around the path of the conveyor 300. For example, a full and/or partial rotation of the first and/or second drive wheels 406, 408 may correspond to a known, predetermined amount of forward or backward movement of the track(s) 500, 600 relative to the drive apparatus 400.

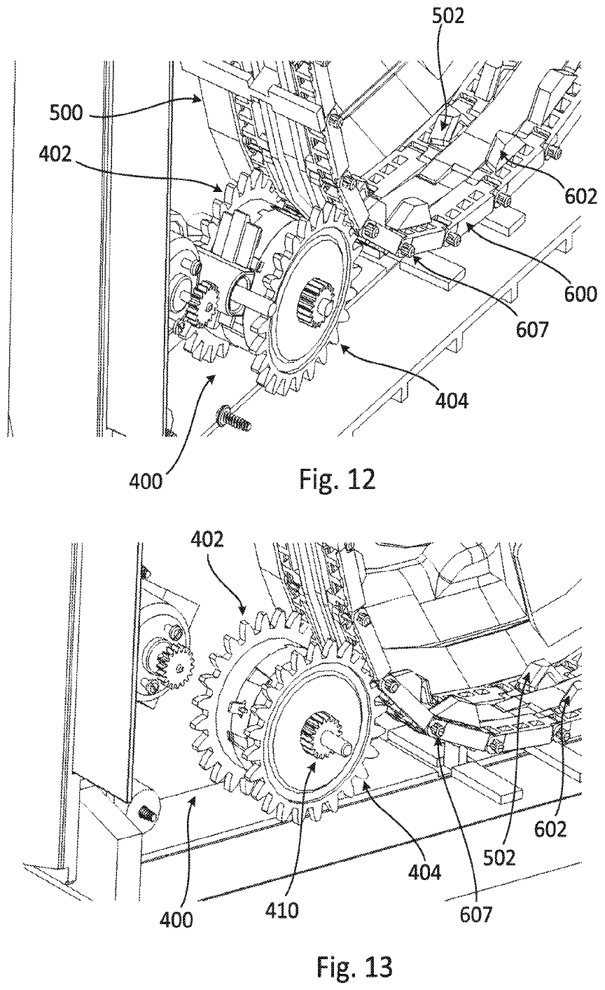

Further illustrations of the drive apparatus 400 engaged with the first and second tracks 500, 600 of the conveyor 300 are shown in FIGS. 12 and 13. While FIG. 11 illustrates the drive apparatus 400 engaged with the tracks 500, 600 along a substantially straight part of the conveyor path, FIGS. 12 and 13 show an arrangement in which the drive apparatus 400 is instead engaged with the first and second tracks 500, 600 as the conveyor path travels around a bend. In particular, in FIGS. 12 and 13, the drive apparatus 400 is shown installed in the money item handling system 100 at a location where the path of the money item conveyor 300 transitions from a substantially horizontal region A, in which new money items may be collected by the conveyor 300 from a money item storage region of the system 100, to an inclined transit region B in which primary money items 800 in the stable configuration described above with respect to FIGS. 2A and 2B are conveyed upwards towards a sensing region C. As shown in FIGS. 12 and 13, in this transition region the path of the conveyor 300 bends through a corner and the drive apparatus 1000 is positioned on the outside of the bend to engage with the drive sides 508, 608 of the first and second tracks 500, 600. In this respect, it will be understood from the discussion above and the illustrations in FIGS. 11-13 that the gap between the first and second drive wheels 406, 408 of the drive apparatus 400 substantially matches the distance between the drive sides 508, 608 of the first and second tracks 500, 600.

In addition to being configured to stably and predictably convey primary money items 800 in very close proximity to the one or more money items sensors 900 in the support 700, the conveyor 300 is also configured to ensure that any surplus money items which may have been collected by one or both of the tracks 500, 600 in the substantially horizontal collecting region mentioned above are not retained on the tracks 500, 600 in the inclined region of the conveyor path. In doing so, the conveyor 300 is arranged to ensure that any such surplus money items do not disturb primary money items 800 on the tracks 500, 600 or, for example, interfere with sensing operations for the primary money items 800.

In the context of this aspect of the technology, although well understood, it is worthwhile mentioning that the main faces of money items such as coins may have a shape which is circular or that can be approximated as a circle (e.g. an n>4-sided polygon such as an octagon, heptagon, hexagon etc.). Furthermore, particular sets of money items, such as the set of coins in a particular currency (e.g. EUR, USD, GBP, etc.), generally include a range of differently sized money items so that the diameters of the money items in the set incrementally varies from largest to smallest. The depth of money items such as coins is generally significantly less than the diameter of the money items' main faces.

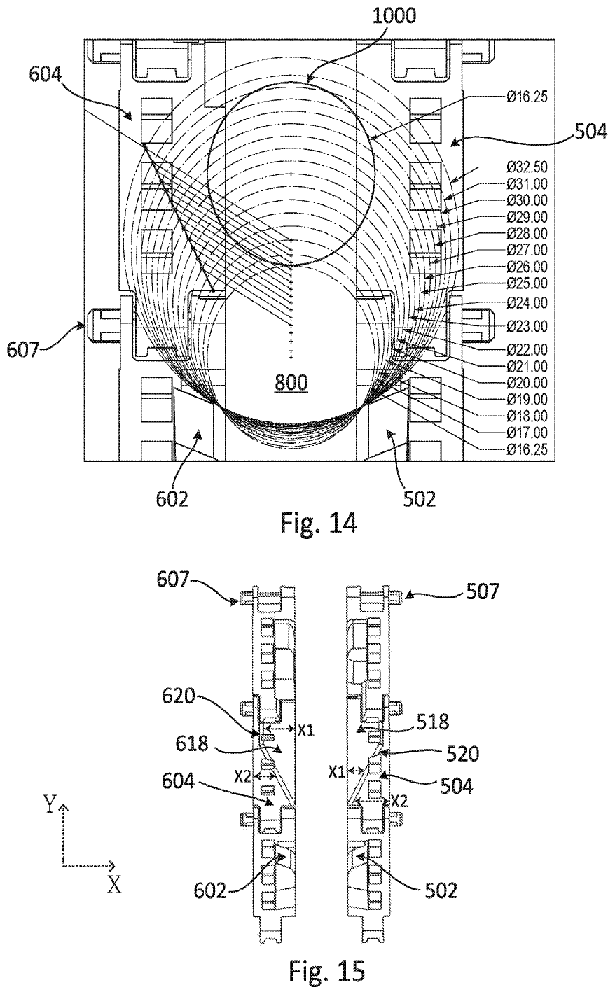

An example of variations in size of money items across a particular set is illustrated in FIG. 14. This figure illustrates the circumferences of a plurality of differently sized money items when accommodated as a primary money item in the primary configuration between the first and second money item conveying elements 502, 602. As shown and described previously with respect to FIG. 2, in this stable configuration, the edge of the money item 800 abuts the first and second money item conveying elements 502, 602, while the lower main face of the money item 800 rests on the money item support surfaces 504, 604 of the first and second tracks 500, 600.

In order to be able to accommodate the largest money item in the set in the primary configuration, each of the money item support surfaces 504, 604 extends forward a sufficient distance from the upstanding conveying elements 502, 602 before reaching an upstanding boundary element 516, 616 which limits the area in which money items can be accommodated forward of the conveying elements 502, 602. This degree of extension means that, when smaller ones of the money items in the set are accommodated in the primary configuration rather than larger ones, a region of the support surfaces 504, 604 is left unoccupied by the primary money item 800 and opens the possibility for a relatively small surplus money item 1000 to sit on the conveyor 300 in a location which is directly forward of the primary money item 800.

For example, as shown in FIG. 14, the rearward edge of a small surplus money item 1000 may abut the forward edge of a small primary money item 800 creating the potential for the surplus money item 1000 to be conveyed forward with the tracks 500, 600 during motion of the conveyor 300. This situation is undesirable because the unstable surplus money item 1000 has the potential to disrupt the general operation of the conveying apparatus 200, for example by creating jams on the conveyor 300 or by interfering with sensing operations for the primary money item(s) 800 on the tracks 500, 600.

In this context, FIG. 15 illustrates an arrangement of the first and second tracks 500, 600 which is configured to contribute to singulating money items on the conveyor 300. In particular, the arrangement contributes to singulating money items so that only primary money items 800, i.e. those in the primary configuration described above, are retained on the tracks 500, 600 during movement of the tracks 500, 600 through the inclined region of conveyor 300 shown in FIGS. 1, 12 and 13. As outlined above with respect to FIG. 2, each section of the first and second tracks 500, 600 comprises a money item support surface 504, 604 which is configured to support a main face of a primary money item 800 whose edge abuts the first and second upstanding conveying elements 502, 602. Examples of these money item support surfaces 504, 604 are illustrated in FIG. 15. The tracks 500, 600 shown in FIG. 15 also each comprise recessed regions in which recessed surfaces 518, 618 are misaligned with the money item support surfaces 504, 604. More particularly, the geometric plane of the recessed surfaces 518, 618 may be substantially parallel with the geometric plane of the support surfaces 504, 604. In this respect, the recessed surfaces 518, 618 may define a base of each recessed region which is ramped down from the money item support surfaces 504, 604 away from the primary money item 800.

The recessed region of each track section 500, 600, including the recessed surface 518, 618, is separated from the money item support surface 504, 604 by a transition line 520, 620 which extends across the track 500, 600 at angle which is non-perpendicular with the longitudinal sides of the track 500, 600. At each of the transition lines 520, 620, a ramp is formed by the meeting of the misaligned support surface 504, 604 and recessed surface 518, 618 of the track section 500, 600. As shown in FIG. 15, the width X1 of the recessed surface 518, 618 of each track section 500, 600 increases with increasing forward distance Y (i.e. along the Y-axis in FIG. 15) from the frontal portions of the upstanding conveying elements 502, 602. Correspondingly, the width X2 of the money item support surface 504, 604 of each track section 500, 600 reduces with increasing forward distance Y from the frontal portions of the conveying elements 502, 602. The relative shapes of the recessed surfaces 518, 618 and the support surfaces 504, 604 of each track section 500, 600 are defined by the transition lines 520, 620 which, as illustrated in FIG. 15, each extend outwardly from an inner side of the track 500, 600, adjacent to the support 700, towards an outer side of the track 500, 600. In this manner, the distance X (i.e. along the X-axis in FIG. 15) across the conveyor 300 between the transition line 520 on the first track 500 and the transition line 620 on the second track 600, as measured perpendicularly to the longitudinal edges of the tracks 500, 600, increases with increasing distance Y from the frontal portions of the money item conveying elements 502, 602.

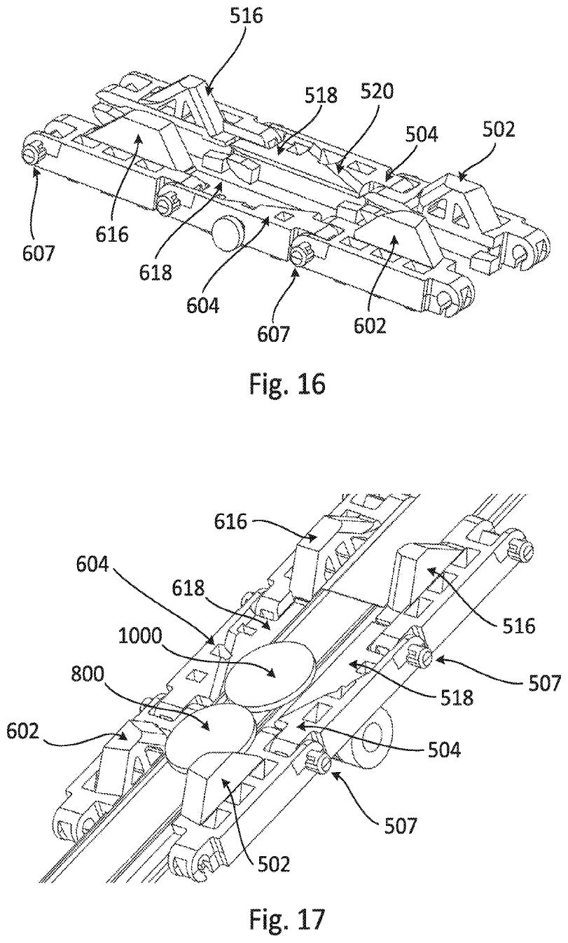

A further view of the recessed surfaces 518, 618 and money item support surfaces 504, 604 of the first and second tracks 500, 600 is illustrated in FIG. 16. In this perspective view, the ramped transition 520 between the recessed surface 518 and the money item support surface 504 of the first track 500, in particular, can be clearly seen. A corresponding arrangement is present on the second track 600.

While FIGS. 15 and 16 illustrate the recessed surfaces 518, 618 and money item support surfaces 504, 604 of the first and second tracks 500, 600 in absence of the money item support 700, FIG. 17 shows the tracks 500, 600 coupled to the support 700 in the manner described above with respect to FIG. 6. FIG. 17 also shows a money item 800 accommodated in the stable, primary configuration on the money item support surfaces 504, 604, with its rearward edge abutting the conveying elements 502, 602, and a surplus money item 1000 located forward of the primary money item 800. The inner region of the main face of the surplus money item 1000 is resting on parts of the surface 706 of the static support 700, while the peripheral regions of the main face of the surplus money item 1000 are overlying the recessed surfaces 518, 618 of the first and second tracks 500, 600. In particular, the inner region of the main face of the surplus money item 1000 may be supported by raised portions 707 of the support surface 706 which extend longitudinally along either edge of the support surface 706. In between these raised portions 707 may be a central part of the surface 706 with which the surplus money item 1000 does not make contact. By supporting the surplus money item 1000 on the raised longitudinal portions 707 of the support 700, rather than by contact across the whole width of the surface 706 of the support 700, frictional resistance to forward movement of the surplus money item 1000 along the path of the conveyor may be reduced. This may be especially beneficial in circumstances where debris and/or tacky residue has accumulated on the central part of the surface 706 of the support 700. As well as in FIG. 17, the raised longitudinal portions 707 of the surface 706 of the support 700 can be seen in FIG. 6.

Meanwhile, as discussed above, during transit towards the sensor(s) 900, the main face of the primary money item 800 may be supported above (and away from contact with) the static support 700 by the money item support surfaces 504, 604 of the first and second tracks 500, 600.

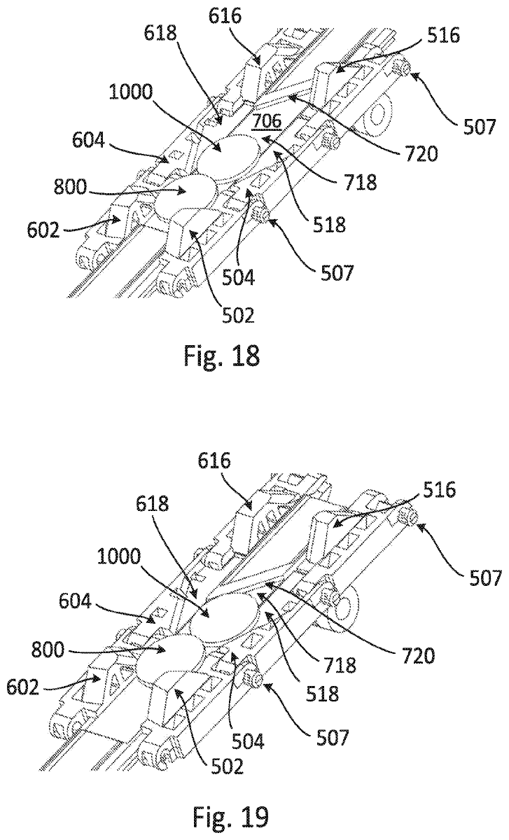

The specific angle of the transition line 520, 620 on each track section 500, 600, and the relative sizes of the money item support surfaces 504, 604 and recessed surfaces 518, 618 which are dictated by the angle of the transition line 520, 620, is selected so as to maximize the conveyor's effectiveness in singulating money items on the conveyor 300. In particular, the geometric relationship between the support surface 504, 604 and recessed surface 518, 618 of each track section 500, 600 is selected to ensure that two functionalities of the conveyor 300 are achieved. The first functionality is to ensure that a money item 800 which has settled in the primary configuration against the conveying elements 502, 602 and support surfaces 504, 604 is conveyed forward in a stable state around the path of the conveyor 300. The second functionality is to ensure that any surplus money item 1000, which may have been inadvertently picked up by the track sections 500, 600 in the horizontal collecting region of the conveyor 300 mentioned above with respect to FIGS. 12 and 13, does not settle in a stable state on the support surfaces 504, 604. Instead, the arrangement of the support surfaces 504, 604 and recessed surfaces 518, 618 means that any surplus money items 1000 settle with their main faces against the surface 706 of the support 700 and overlying or overhanging the recessed surfaces 518, 618 of the tracks 500, 600 in an ejection configuration on the conveyor 300. This is discussed further below in the context of FIGS. 18-23.

FIG. 18 illustrates a progression of the situation described above with respect to FIG. 17, in which a first money item 800 is accommodated on the track sections 500, 600 in the primary configuration and a second, surplus money item 1000 is accommodated in the ejection configuration. In FIG. 18, the surplus money item 1000 is in a money item ejection region of the conveyor 300, in which a portion of the static support 700 is arranged to direct the surplus money item 1000 off the conveyor 300 to leave only the primary money item 800 in place. The ejection portion of the support 700 comprises a recessed region 718 of the surface 706 of the support 700 and an ejection element 720 which extends across the surface 706 of the support 700 as a boundary to the recessed region 718. In the recessed region 718, the geometric plane of the support surface 706 may be aligned with the geometric planes of the recessed surfaces 518, 618 of the first and second tracks 500, 600 so that a surplus money item 1000 may simultaneously overly both the support surface 706 and the recessed surface(s) 518, 618 of the first and/or second tracks 500, 600. Alternatively, engagement between the tracks 500, 600 and the support 700 may be such that the planes of the recessed surfaces 518, 618 of the tracks 500, 600 are a little below the plane of the support surface 706 in the recessed region 718. This allows the surplus money item 1000 to overhang the edges 702, 704 of the support 700 unsupported by the recessed surfaces 518, 618 of the tracks 500, 600. Overall, depending on the speed of the tracks 500, 600 and the angle of incline of the conveyor 300 in the money item ejection region, the effect may be that the surplus money item 1000 lies with its main face substantially flat against the recessed region 718 of the support surface 706 during forward movement of the tracks 500, 600 through the ejection region illustrated in FIG. 18. In this scenario, compared with the situation shown in FIG. 17, the surplus money item 1000 drops downward under gravity (e.g. over a step or cliff 722 described below) onto the recessed region 718 of the surface 706 of the support 700.

The plane of the recessed region 718 of the surface 706 of the support 700 is non-aligned with the planes of the money item support surfaces 504, 604 on the first and second tracks 500, 600. This is illustrated in FIG. 18, where it can be seen that the recessed region 718 is stepped down from the support surfaces 504, 604 on the tracks 500, 600. The non-aligned planes of the money item support surfaces 504, 604 and the recessed region 718 of the support 700 is evident from the relationship between the primary and surplus money items 800, 1000 illustrated in FIG. 18. Specifically, the principal geometric plane of the surplus money item 1000 is partially non-aligned with the principal geometric plane of the primary money item 800 due to the corresponding non-alignment between the support surfaces 504, 604 of the tracks 500, 600 and the recessed region 718 of the support 700.

It can be seen that the money item 800 in the primary configuration is supported by the money item support surfaces 504, 604 above the recessed region 718 of the support 700 so that, while being conveyed through the ejection region of the conveyor 300, the main face of the primary money item 800 continues to span the support 700 without physically interacting with the ejection element 720. Instead, the support surfaces 504, 604 of the tracks 500, 600 support the money item 800 above the ejection element 720 so that the money item 800 passes directly over the ejection element 720 without being disrupted from its primary configuration. At the same time, the depth of the primary and surplus money items 800, 1000 means that, even when the surplus money item 1000 is in the recessed region 718 of the support 700, there is sufficient abutment between the forward edge of the primary money item 800 and the rearward edge of the surplus money item 1000 for the primary money item 800 to continue to push the surplus money item 1000 forward with movement of the tracks 500, 600. Even should there no longer be abutment between the primary and surplus money items 800, 1000 in the ejection region, the surplus money item 1000 may nevertheless continue forward towards the ejection element 720 due to its own momentum. This may be the case even when the ejection region is in an inclined region (e.g. region B) of the conveyor 300. The speed at which the tracks 500, 600 propel the primary money item 800 up the inclined region B may, for example, be approximately 300 mm/s. At an incline angle of approximately 15 to 20 degrees, for example, such a speed is sufficient for the momentum of the surplus money item 1000 to carry it through the ejection region into contact with the ejection element 720 even if there is no longer any abutment with the primary money item 800. In this scenario, it should be appreciated that although the surplus money item 1000 is described above as lying substantially flat against the recessed region 718 of the support surface 706 during forward movement of the tracks 500, 600 through the ejection region, it may alternatively be the case that the surplus money item 1000 having entered the ejection region (e.g. by travelling over the cliff or step 722) does not lie flat against the recessed region 718 of the support surface 706 but instead travels unsupported towards the ejection element 720 with minimal or zero contact with the recessed region 718 of the support surface 706. As it does so, the leading edge of the surplus money item 1000 will tip downward under gravity toward the recessed region 718 of the support surface 706 so that the main plane of the surplus money item 1000 becomes non-aligned with that of the primary money item 800. The leading edge of the surplus money item 1000 may then strike the ejection element 720 while the primary money item 800, which remains supported by the tracks 500, 600, continues to be conveyed forward uninterrupted past the ejection region. The action of the ejection element is described below.

The ejection element 720 comprises a stepped portion of the support surface 706 which extends across the support 700 from the first side 702 to the second side 704 mentioned above in relation to FIG. 2. The height of the ejection element 720 may be around 1 mm. The angle of the ejection element 720 is non-perpendicular to the conveying direction of the conveyor 300 and the longitudinal axes of the support 700 and first/second tracks 500, 600. At the ejection element 720, the recessed region 718 of the support surface 706, into which the surplus money item 1000 has been pushed by the primary money item 800 by movement of the first and second tracks 500, 600, abruptly ends and the plane of the support surface 706 returns back to its former level which, as outlined above, may be close to being aligned with the support surfaces 504, 604 of the tracks 500, 600.

As the surplus money item 1000 is pushed forward by the primary money item 800 and/or travels forward under its own momentum as described above, it strikes the stepped ejection element 720. The reactionary force on the edge of the surplus money item 1000 caused by contact between the edge of the money item 1000 and the ejection element 720 causes the surplus money item 1000 to change direction towards the first track 500. In particular, the contact between the forward edge of the surplus money item 1000 and the stepped ejection element 720 causes the surplus money item 1000 to be directed over the recessed surface 518 of the first track 500 and off the conveyor 300 via the outer edge of the first track 500.

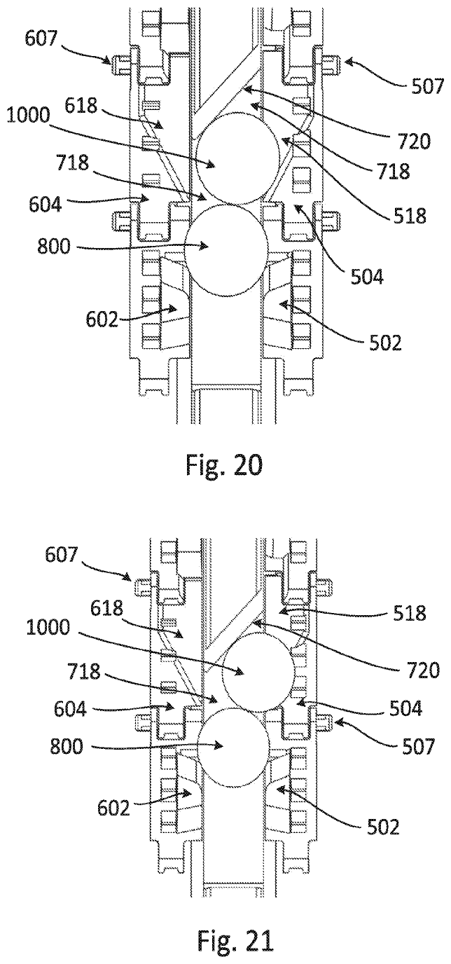

This process of ejecting a surplus money item 1000 from the conveyor 300 is described further below in relation to FIGS. 19-21. Referring firstly to FIG. 19, the surplus money item 1000 shown in FIG. 18 has travelled forward through the recessed region 718 of the elongated support 700 to a location where its front edge abuts the angled, stepped face of the static ejection element 720. At this point, contact with the ejection element 720 causes the surplus money item 1000 to begin to move across the conveyor 300 over the recessed surface 518 of the first track 500. A similar stage of the ejection process is shown by the plan view in FIG. 20.

In FIG. 21, the tracks 500, 600 have moved further forward and the process of ejecting the surplus money item 1000 from the conveyor 300 has progressed to a point where the peripheral edge of the surplus money item 1000 has been directed up and across the ramped transition line 520 between the recessed surface 518 and the support surface 504 of the first track 500. In this latter stage of the ejection process, the surplus money item 1000 is approaching the outer longitudinal edge of the first track 500 where, in a final stage of the ejection process, the surplus money item 1000 will fall off the conveyor 300 as it travels even further across the first track 500.

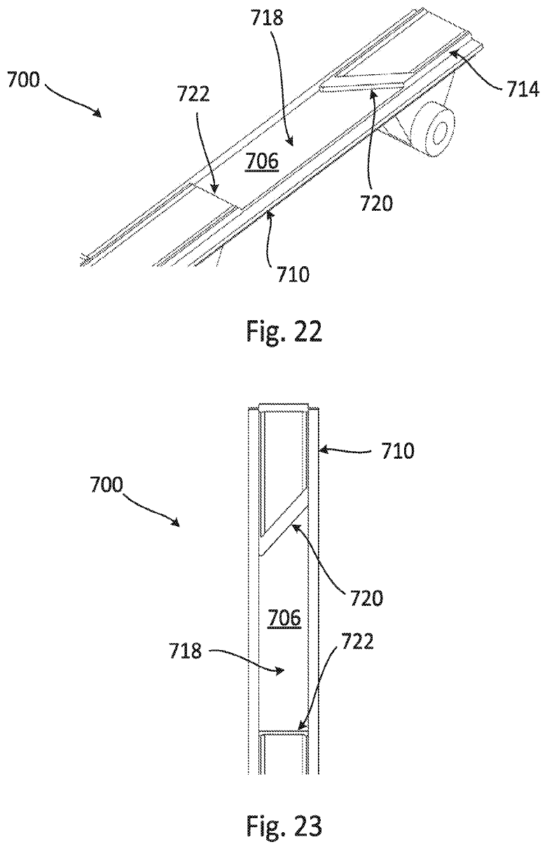

The portion of the static support 700 which is arranged to direct money items off the conveyor 300 in the ejection region discussed above is further illustrated in FIGS. 22 and 23. In these figures, the ejection portion of the support 700 is shown in absence of the money items 800, 1000 and the first and second tracks 500, 600 which are illustrated in FIGS. 17-21. As can be seen, boundaries of the ejection portion are formed by stepped transitions at which the surface 706 of the support 700 abruptly changes geometric planes.

A first of the stepped transitions is the money item ejection element 720 discussed above, which extends across the support 700 at angle which directs surplus money items 1000 in the recessed region 718 of the support 700 to move over the first track 500 and off the conveyor 300. A second of the stepped transitions is a cliff 722 in the surface 706 of the support and defines the beginning of the ejection portion (viewed from the perspective of money items moving in the direction of travel of the conveyor 300). Like the ejection element 720, the cliff 722 extends across the support 700 from the first side 702 to the second side 704. Unlike the ejection element 720, however, the cliff 722 does not serve the function of directing surplus money items 1000 off the conveyor 300 but instead serves to drop surplus money items into the recessed region 718 of the support to position them for ejection. To serve this function, the cliff 722 is not required to extend non-perpendicularly across the support 700 in the manner of the ejection element 720 but instead may extend perpendicularly to the longitudinal sides 702, 704 of the support 700 to facilitate an effective movement of surplus money items 1000 into the ejection configuration as they pass over the cliff 722. The height of the cliff 722 may be around 1 mm.

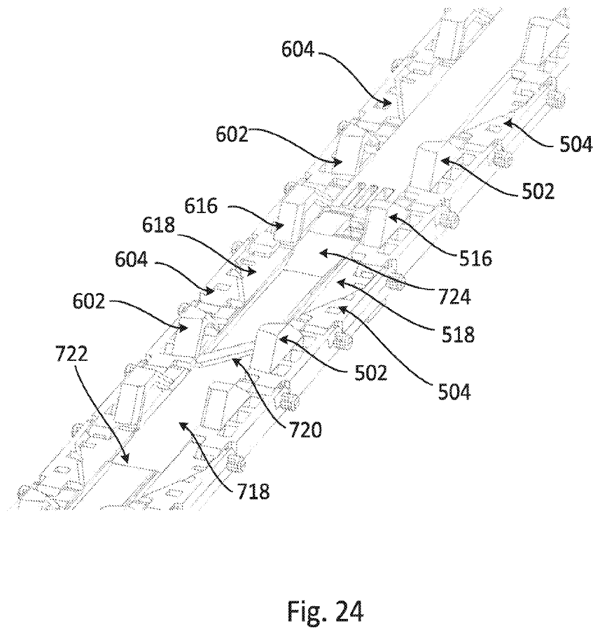

FIG. 24 shows a further view of the ejection region of the support 700, together with the first and second tracks 500, 600 on either side. In this figure, the first and second stepped transitions 720, 722 in the surface 706 of the support 700 are clearly shown. Also shown is a third transition region 724 in which the surface 706 of the support 700 rises towards the money item support surfaces 504, 604 of the first and second tracks 500, 600. This ramped transition region 724 is an example of how the surface of the support 700 may change its geometrical relationship with the tracks 500, 600 as the path of the conveyor 300 enters the sensing region C referred to above. As previously discussed, in the region C of the sensor(s) 900, and particularly as primary money items 800 are conveyed over the sensor(s) 900 embedded in the support 700, the surface 706 of the support 700 may rise above the money item support surfaces 504, 604 so that the main face of the primary money item 800 slides along the surface 706 of the support 700 (due to continuous contact with the conveying elements 502, 602 of the tracks 500, 600) rather than being supported by the money item support surfaces 504, 604 of the first and second tracks 500, 600.

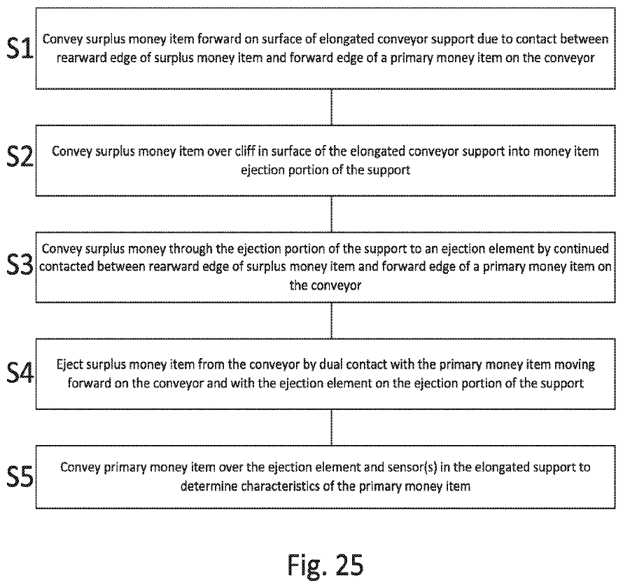

A process of ejecting a surplus money item 1000 from the conveyor 300 and sensing characteristics of a primary money item 800 remaining on the tracks 500, 600 after the surplus money item 1000 has been ejected is further described below with respect to FIG. 25. However, although for conciseness the ejecting and sensing operations are described here in relation to the single process flow shown in FIG. 25, it is important to appreciate that the ejection of the surplus money item 1000 and the sensing of characteristics of the primary money item 800 are separate functionalities of the system 100 that are not inextricably linked together. Each of the functionalities may be implemented independently of the other and it is not necessary, for implementation of either one of the functionalities, for the system 100 to include equipment associated with the other functionality.

In a first stage S1 of the process the surplus money item 1000, which has been inadvertently collected by the track sections 500, 600 during passage of the track sections through a money item collecting region of the conveyor 300, has settled with its main face lying against the surface 706 of the static support 700 between the tracks 500, 600. The surplus money item 1000 has its rearward edge abutting the forward edge of another money item 800, which is accommodated in a primary configuration between the conveying elements 502, 602 of the track sections 500, 600. As the track sections 500, 600 move around the path of the conveyor 300 under the power of the drive apparatus 400, the money item 800 in the primary configuration is conveyed forward, as described above, due to continuous contact between its rearward edge and the frontal portions of the conveying elements 502, 602 on the track sections 500, 600. At the same time, the surplus money item 1000 is also conveyed forward, as the same rate as the primary money item 800, due to sustained contact between its rearward edge and the forward edge of the primary money item 800.

In a second stage S2 of the process, the surplus money item 1000 is conveyed by the contact with the primary money item 800, over the cliff 722 in the surface 706 of the support 700 and into the money item ejecting portion of the support 700. Here, the main face of the surplus money item 1000 drops under gravity towards the recessed region 718 of the support surface 706, below the geometric plane of the primary money item 800. The primary money item 800 does not drop down into the recessed region 718 of the support 700 because, unlike for the surplus money item 1000, the money item support surfaces 504, 604 of the first and second tracks 500, 600 continue to support the primary money item 800 as it is conveyed over the cliff 722 in the surface 706 of the support 700. While the geometric plane of the surplus money item 1000 changes abruptly as it travels over the cliff 722, no such abrupt change is seen with respect to the primary money item 800.

In a third stage S3 of the process, partial abutment between the surplus money item 1000 in the recessed region 718 of the support 700 and the primary money item 800 on the track sections 500, 600, as shown in FIG. 18, means that the surplus money item 1000 continues to be driven forward over the surface 706 of the support 700 towards the ejection element 720. Alternatively, as described above, the surplus money item 1000 may simply continue forward towards the ejection element 720 under its own momentum.

In a fourth stage S4 of the process, the surplus money item 1000 reaches the ejection element 720. Contact between the surplus money item 1000 and the ejection element 720 changes the direction of travel of the surplus money item 1000 and causes the surplus money item 1000 to move over the recessed surface 518 of the first track 500 and off the conveyor 300. Meanwhile, the primary money item 800 is conveyed over the top of the ejection element 720 and continues to progress along the path of the conveyor 300 in the primary configuration.

In a fifth stage S5 of the process, the primary money item 800 is conveyed further forward, by the conveying elements 502, 602 of the first and second tracks 500, 600, over the one or more sensors 900 which are embedded in the elongated support 700 in the manner shown in FIG. 2. As previously discussed, the arrangement of the sensor(s) 900 relative to the path along which primary money items 800 are conveyed means that the centres of the main faces of primary money items 800 pass directly over the sensor(s) 900. Furthermore, the distance between the sensor(s) 900 and the main faces of the primary money items 800 may be as small as the distance between the main faces of the primary money items 800 and the surface 706 of the support 700. If the primary money item 800 is being pushed along the surface 706 of the support 700 in the region of the sensor(s) 900, as shown in FIGS. 2-4, the distance between the sensor(s) 900 and the money item 800 is minimal. These factors contribute to the sensor(s) being able to take accurate and reliable measurements of the characteristics of the primary money items 800. The measurement conditions are consistent from money item 800 to money item 800, meaning that the configuration of the sensor(s) 900 can be highly optimized for the particular conditions provided by the conveyor 300.

The sensor(s) 900 may be configured to generate signals representative of one or more characteristics of the primary money items 800 passing over the sensor(s) 900. These signals may then be provided to a computing apparatus 1100, which is configured to determine characteristics of the money items 800 from the signals. The characteristics may include physical properties of the money item 800 such as the colour(s) or mass of the money item 800 and/or geometric attributes of the money item 800, such as its depth, its radius, its diameter or other chord measurements. Properties and attributes of this kind may be determined from signals created by one or more optical sensors. Additionally or alternatively, the determined characteristics may include electromagnetic responses of the primary money item 800. Electromagnetic attributes of this kind may be determined from signals created by one or more electromagnetic sensors, which may be configured to generate one or more electromagnetic fields intended to cause a response from the money item 800.

As will be appreciated by a person skilled in the art, the characteristics of the money item 800 may be used by the computing apparatus 1100 to identify the type of each money item 800 for example by denominating the money item as having a particular value in a particular national or regional currency. Additionally or alternatively, the characteristics of the money item 800 may be used by the computing apparatus 1100 to determine whether or not the money items 800 are authentic, for example by validating the money item 800 as having a range of characteristics which correspond to those of known money items from a particular national or regional currency.

Referring back to FIG. 1, the money item handling system 100 may comprise a money detection apparatus 1200 as a means of mitigating against the possibility of undesirably positioned money items on the conveyor 300 causing operational disruption and/or damage to the system 100. The detection apparatus 1200 may act in combination with the surplus money item ejection functionality of the money item conveyor 300 which, as described above, ejects surplus money items 1000 lying directly in front of primary money items 800 on the conveyor 300. Alternatively, the detection apparatus 1200 may be deployed in systems 100 in which the conveyor does not have the surplus money item ejection functionality described above. Similarly, the surplus money item ejection functionality described above may be provided on conveyors which operate in systems without the detection apparatus 1200.

The money item detection apparatus 1200 is arranged adjacent to the conveyor 300. For example, as shown in FIG. 1, the detection apparatus 1200 may be located in an inclined region B of the conveyor path. As discussed above, the money item sensor(s) 900 in the static guide 700 discussed above may also be located in an inclined region C of the conveyor path. As money items 800 are conveyed around the path of the conveyor 300, they may pass by the detection apparatus 1200 before reaching the location of the sensor(s) 900. For example, the money item detection apparatus 1200 may be located immediately before the sensing region C as shown in FIG. 1.

The functionality of the detection apparatus 1200 is to detect money items which have been collected by the conveyor 300 but which are poorly or otherwise undesirably positioned on the tracks 500, 600. Such money items have the potential to cause disruption to the conveying apparatus 200 and wider system 100 by becoming jammed in narrow areas of the conveyor 300 or by falling into regions of the system 100 where they may negatively affect the operation or durability of the system 100. The detection apparatus 1200 reduces the possibility of jams and other types of disruption by detecting the presence of such money items before they reach regions of the conveyor 300 which are particularly restricted in size (e.g. narrow or shallow regions) or otherwise particularly vulnerable to damage or disruption by undesirably positioned money items. An example of such a region may be the sensing region C of the conveyor 300. Upon detecting money items which are undesirably positioned in the manner described above, the detection apparatus 1200 may be configured to automatically halt movement of the tracks 500, 600 of the conveyor 300. For example, the money item detection apparatus 1200 may be configured to respond to detection of an undesirably positioned money item by causing a ‘stop’ signal to be communicated to the drive apparatus 400 by a communication coupling between the drive apparatus 400 and detection apparatus 1200. In such a scenario, the drive apparatus 400 may firstly be configured to stop forward movement of the tracks 500, 600 to prevent undesirably positioned money item(s) from entering potentially vulnerable regions of the conveyor 300. Secondly, the drive apparatus 400 may then reverse the direction of movement of the tracks 500, 600 for a short period of time so that any undesirably positioned money items are driven away from sensitive regions of the conveyor path. Such money items are then likely to naturally fall off the tracks 500, 600 and hence away from any position where they might cause damage or disruption to the conveyor 300. Normal operation of the conveyor 300 may then be resumed, without the need for any physical intervention (e.g. to clear the undesirably positioned money items from the tracks 500, 600) by a service engineer.

With regard to the general functionality of the detection apparatus 1200 discussed above, and particularly with respect to preventing damage or significant disruption to the conveyor 300, the detection apparatus 1200 may have a degree of inbuilt tolerance which allows the tracks 500, 600 to continue to move forward a certain amount, after initial detection of an undesirably positioned money item, without any undesirably positioned money items entering vulnerable regions of the conveyor 300. In this way, the detection apparatus 1200 may give time for the tracks 500, 600 to be brought to a halt without any damage being caused to the conveyor 300 or wider system 100 during this process.

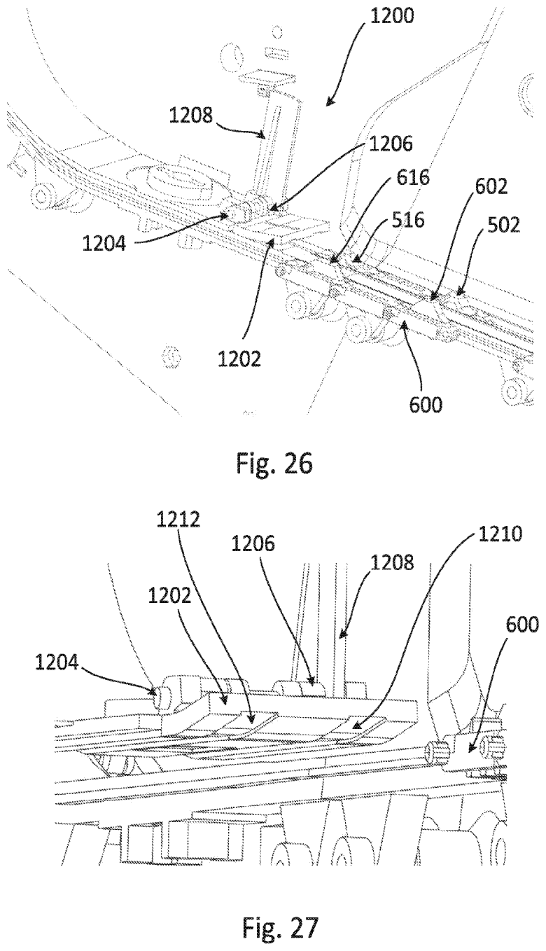

Referring to FIG. 26, the money item detection apparatus 1200 comprises a money item contact region in the form of an element 1202 which is pivotably coupled to a pivot 1204. The coupling between the contact element 1202 and the pivot 1204 may comprise a rigid mechanical link 1206 which directly connects the contact element 1202 to the pivot 1204 so that mechanical pressure on the contact element 1202 causes the contact element 1202 to move relative to the pivot 1204. The detection apparatus 1200 also comprises a trigger region in the form of a trigger element 1208 which is fixedly connected to the contact element 1202 so that movement of the contact element 1202 relative to the pivot 1204 causes a corresponding movement in the trigger element 1208. As described below, the detection apparatus 1200 is configured in a manner which means that mechanical pressure on the contact element 1202 from an undesirably positioned money item on the conveyor 300 causes the trigger element 1208 to move from a first position, in which the tracks 500, 600 of the conveyor 300 are permitted to move around the conveyor path, to a second position in which movement of the conveyor tracks 500, 600 is prevented.

For example, movement of the trigger element 1208 from the first position, in which the trigger element 1208 naturally resides, for example by being appropriately weighted (e.g. by the contact element 1202), to the second position may trigger communication of a signal from the detection apparatus 1200 to the drive apparatus 400. The signal causes the drive apparatus 400 to cease or otherwise prevent movement of the conveyor tracks 500, 600, for example by halting motion of the drive wheels 406, 408, thereby preventing the money item detected by the detection apparatus 1200 from being conveyed further along the path of the conveyor 300.

Referring to the example illustrated in FIG. 26, the pivot 1204 may comprise a rigid bar which is fixedly attached to a static body of the conveying apparatus 200 or, alternatively, the wider money item handling system 100. The mechanical link 1206 may comprise a rigid element in which an aperture accommodates the rigid bar of the fixed pivot 1204. The contact element 1202 may comprise an extension from the mechanical link 1206. In the example of FIG. 26, the extension of the contact element 1202 is non-planar and has a shallow curve which increases the distance between the contact element 1202 and the conveyor tracks 500, 600 towards a leading edge of the contact element 1202 (i.e. the edge which money items first encounter when being conveyed along the path of the conveyor 300). The aperture and associated mechanical link 1206 are able to freely rotate around the bar of the pivot 1204 so that the contact element 1202 and, by consequence, the trigger element 1208 are able to freely move in response to forces exerted on the contact element 1202 by rogue money items on the conveyor 300.

The conveyor-side of the contact element 1202, the pivot 1204 and the mechanical link 1206 are illustrated in greater detail in FIG. 27. As can be seen, the conveyor-side of the contact element 1202 may comprise first and second channels 1210, 1212 which extend longitudinally across the contact element 1202 in the conveying direction of the conveyor 300 to accommodate upstanding elements 502, 602, 516, 616 of the tracks 500, 600 as the tracks 500, 600 pass by the detection apparatus 1200. The channels 1210, 1212 ensure that the contact element 1202 may be positioned close to the conveyor tracks 500, 600 and elongated support 700, so as to physically detect rogue money items on the conveyor 300, without risk of the contact element 1202 and associated trigger element 1208 being moved simply by passage of the upstanding elements 502, 602, 516, 616 past the detection apparatus 1200.

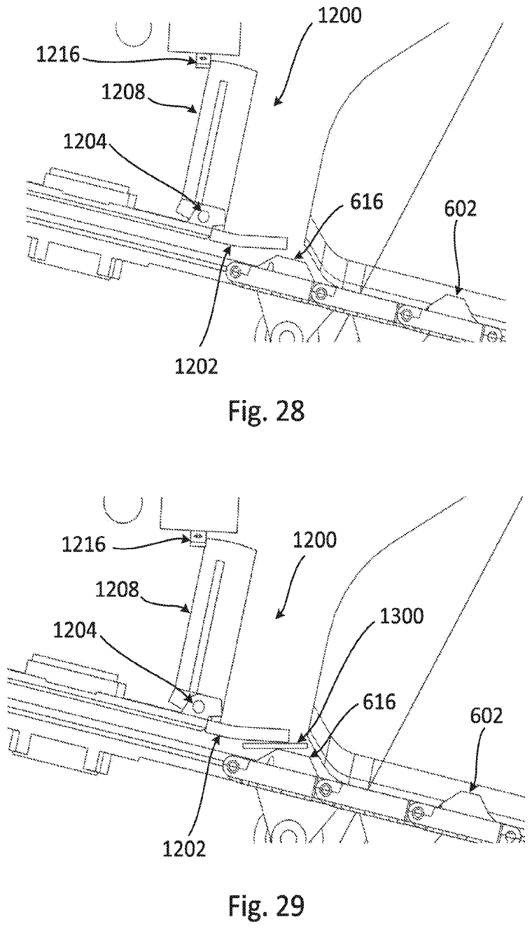

Side-on views of the money item detection apparatus 1200 and a section of the conveyor 300 are shown in FIGS. 28 and 29. In FIG. 28, an upstanding conveying element 602 and boundary element 616 of a near-side track 600 of the conveyor 300 are illustrated as approaching the contact element 1202 of the detection apparatus 1200. On the opposite side of the conveyor 300, although hidden from view in FIG. 27, corresponding conveying and boundary elements 502, 516 of a far-side track 500 may also be approaching the contact element 1202. The trigger element 1208 of the detection apparatus 1200 is in the first position referred to above, which the element 1208 may naturally adopt when not being physically influenced by rogue money items on the conveyor 300.

In FIG. 28, there are no money items on the illustrated section of the conveyor 300 and, as such, the section of the conveyor 300 will progress past the money item detection apparatus 1200 without significantly interacting with the contact element 1202 or changing the position of the trigger element 1208. For example, as described above, the upstanding elements 502, 602, 516, 616 may pass through the channels 1210, 1212 on the conveyor-side of the contact element 1202 so that there is zero (or inconsequential) physical contact between the conveyor tracks 500, 600 and the contact element 1202.

FIG. 29 illustrates a corresponding situation to that shown in FIG. 28, but with the difference that a rogue money item 1300 is located in a disruption configuration on the conveyor 300. In particular, the money item 1300 is balanced in an unstable and undesirable position on an upstanding boundary element 616 of the near-side track 600. The illustrated configuration of the money item 1300 is only one example of many possible undesirable disruption configurations in which money items are not settled on the surfaces 706, 504, 604 of the support 700 and/or tracks 500, 600. In these undesirable configurations, where the principal plane of the money item 1300 is non-aligned with the support surfaces 504, 604 of the tracks 500, 600 due to the money item being balanced on an upstanding element 502, 602, 516, 616 of the conveyor 300, the money item detection apparatus 1200 is configured to detect the money item 1300 and prevent significant further movement of the conveyor tracks 500, 600.

In particular, as the money item 1300 reaches the leading edge of the contact element 1202, the upstanding element 616 on which the main face of the money item 1300 is resting pushes the money item 1300 against the conveyor-side of the contact element 1202 and forces the contact element 1202 to move with respect to the pivot 1204. As this occurs, the leading edge of the contact element 1202 is pushed away from the tracks 500, 600 and causes the attached trigger element 1208 to transition from the first position to the second position discussed above. In the second position, the signal which causes the tracks 500, 600 of the conveyor 300 to not move any significant distance further around the conveyor path is communicated to the drive apparatus 400.

The signal which is communicated to the drive apparatus 400 may be triggered by actuation of a switch. The switch may comprise one or more sensors of the detection apparatus 1200, which sense when the trigger element 1208 is in the second position. In FIGS. 28 and 29, the sensor of the detection apparatus 1200 may be an optical sensor 1216 comprising an optical transmitter and an optical detector. When the trigger element 1208 is moved into the second position, or out of the first position, the optical path between the transmitter and the detector of the sensor 1216 may be blocked by an opaque region of the trigger element 1208. Under these sensing conditions, the detection apparatus 1200 may generate the signal indicative of the rogue money item 1300 on the conveyor 300 so that the drive apparatus prevents the money item 1300 from being conveyed into more vulnerable regions of the conveyor path and thereby preventing jams and other operational disruption. It should be appreciated that, where an optical sensor 1216 is used, an alternative implementation is to deploy a transmitter and a detector either side of the trigger element 1208 in the first position. In this implementation, movement of the trigger element 1208 out of the first position unblocks the optical path between the transmitter and the detector and thereby initiates the ‘stop’ signal discussed above. It should also be appreciated that other types of e.g. non-optical switch can alternatively be used, such one or more mechanical switches.

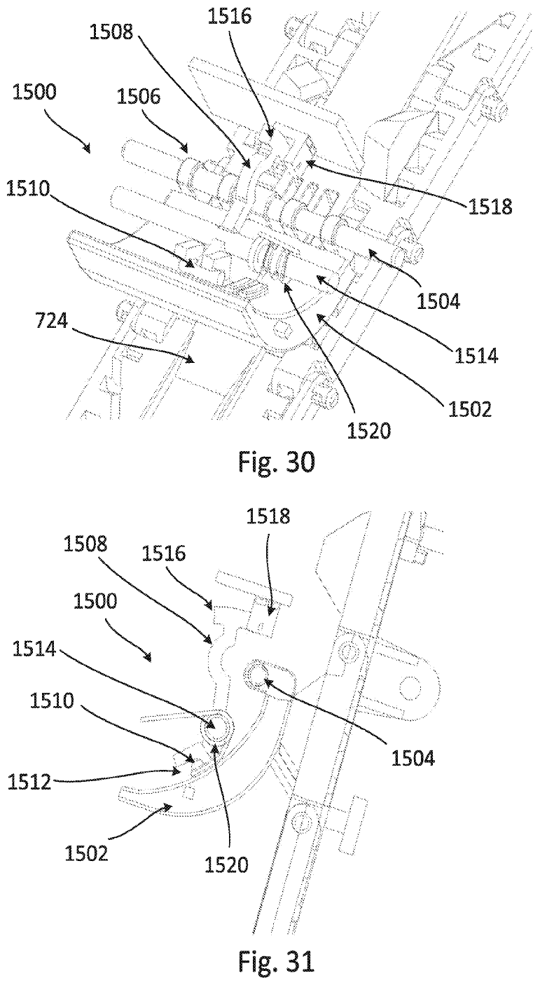

Another implementation of the money item detection apparatus is shown in FIGS. 30 to 32. As with the example 1200 described above, the apparatus 1500 of FIGS. 30 to 32 comprises a money item contact region in the form of an element 1502 which is pivotably coupled to a pivot 1504. The coupling between the contact element 1502 and the pivot 1504 comprises a mechanical link 1506 which directly connects the contact element 1502 to the pivot 1504 so that mechanical pressure on the contact element 1502 causes the contact element 1502 to move around the pivot 1504. The detection apparatus 1500 also comprises a trigger region in the form of a trigger element 1508 which is coupled to the contact element 1502 so that movement of the contact element 1502 relative to the pivot 1504 causes a corresponding movement in the trigger element 1508. As with the apparatus 1200 previously described, the detection apparatus 1500 is configured in a manner which means that mechanical pressure on the contact element 1502 from an undesirably positioned money item on the conveyor 300 causes the trigger element 1508 to move from a first position, in which the tracks 500, 600 of the conveyor 300 are permitted to move around the conveyor path, to a second position in which forward movement of the conveyor tracks 500, 600 is halted in order to prevent jams, disruption and/or damage to the system 100.

For example, movement of the trigger element 1508 from the first position, towards which the trigger element 1508 is naturally sprung by a sprung element 1520 and/or naturally weighted, to the second position may trigger communication of a signal from the detection apparatus 1500 to the drive apparatus 400. As previously described, the signal causes the drive apparatus 400 to cease or otherwise prevent significant further movement of the conveyor tracks 500, 600, for example by halting motion of the drive wheels 406, 408, thereby preventing the rogue money item detected by the detection apparatus 1200 from being conveyed further along the path of the conveyor 300.

Referring to FIGS. 30-32, in this example the pivot 1504 may comprise a rigid bar which is fixedly attached at either end to a static body of the conveying apparatus 200 or, alternatively, the wider money item handling system 100. As with the example 1200 shown in FIGS. 26-29, the mechanical link 1506 may comprise one or more rigid elements which accommodate the rigid bar of the fixed pivot 1504, for example by forming one or more apertures through which the rigid bar extends to be retained in position. The contact element 1502 may comprise an extension from the mechanical link 1506, or may otherwise be coupled to the mechanical link so that it may move with respect to the pivot 1504. As shown in FIG. 30, the contact element 1502 is non-planar and may have a shallow curve which increases the distance between the contact element 1502 and the conveyor tracks 500, 600 towards a leading edge of the contact element 1502 (i.e. the edge which money items first encounter when being conveyed along the path of the conveyor 300). The aperture and associated mechanical link 1506 are able to freely rotate around the bar of the pivot 1504 so that the contact element 1502 and, by consequence, the trigger element 1508 are able to freely move in response to forces exerted on the contact element 1502 by rogue money items on the conveyor 300.

As with the example apparatus 1200 described above, the conveyor-side of the contact element 1502 may comprise first and second channels which extend longitudinally across the contact element 1502 in the conveying direction of the conveyor 300 to accommodate upstanding elements 502, 602, 516, 616 of the tracks 500, 600 as the tracks 500, 600 pass by the detection apparatus 1500.

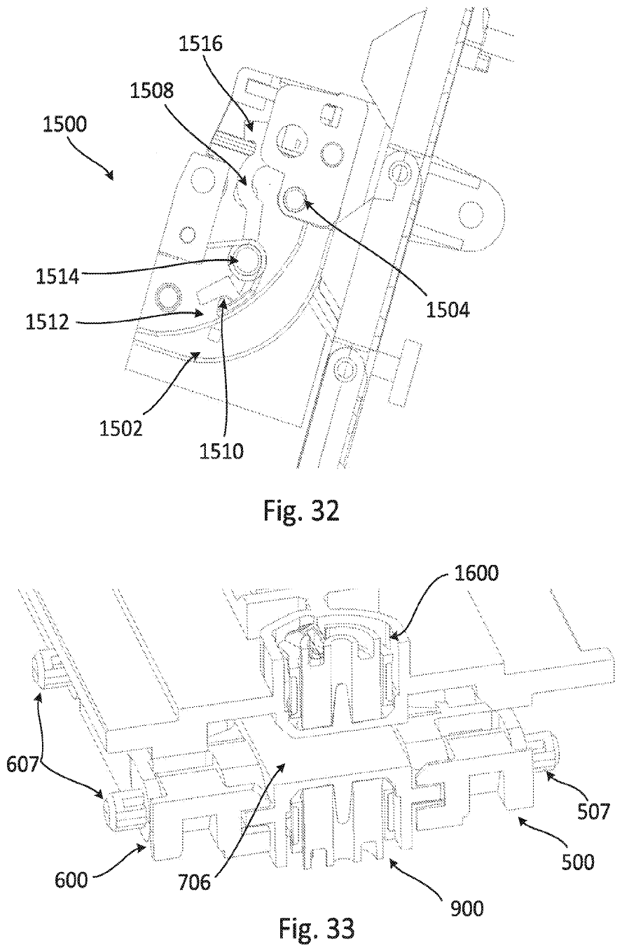

Side-on views of the money item detection apparatus 1500 and a section of the conveyor 300 are shown in FIGS. 31 and 32. In these figures, the trigger element 1508 of the detection apparatus 1500 is in the first position referred to above, which the element 1508 may naturally adopt when not being physically influenced by rogue money items on the conveyor 300. When there are no rogue money items, the tracks 500, 600 will progress past the money item detection apparatus 1500 without significantly interacting with the contact element 1502 or changing the position of the trigger element 1508. However, when a money item in a disruption configuration of the kind described above with respect to FIG. 29 is present on the tracks 500, 600, the contact element 502 is forced by contact with the rogue money item to move around the pivot 1504. As this occurs, the leading edge of the contact element 1502 is pushed away from the tracks 500, 600 and causes the attached trigger element 1508 to transition from the first position to the second position discussed above. In the second position, the signal which causes the tracks 500, 600 of the conveyor 300 to not move any significant distance further around the conveyor path is communicated to the drive apparatus 400. In this regard, FIG. 31 shows how a first end 1510 of the trigger element 1508 proximal to the contact element 1502 may reside in a slot 1512 on the contact element 1502. When the contact element 1502 is moved away from the tracks 500, 600 by a rogue money item on the tracks 500, 600, this movement forces the first end 1510 of the trigger element 1508 to correspondingly move within the slot 1512. As this occurs, the trigger element 1508 pivots around a secondary pivot 1514 which, like the primary pivot 1504 described above, is fixedly attached to a static body of the conveying apparatus 200 or, alternatively, the wider money item handling system 100. The secondary pivot 1514 may comprise a bar or other alternative element which forms a fixed axis around which the trigger element 1508 can move. The movement of the trigger element 1508 around the secondary pivot 1514 causes a second end 1516 of the trigger element 1508 to activate a switch of the kind previously discussed. For example, FIG. 31 shows a switch comprising an optical sensor 1518. As the first end 1510 of the trigger element 1508 is forced to move away from the tracks 500, 600 inside the slot 1512, the second end 1516 of the trigger element 1508 correspondingly moves in an opposing direction into the region of the sensor 1518. Here, having moved from the first position to the second position, the second end 1516 of the trigger element 1508 may disrupt an optical path between a transmitter and receiver of the switch and thereby initiate the ‘stop’ signal referred to above.

As mentioned previously, other types of switch may alternatively be used. For example, in optical-based implementations without an optical transmitter, the opaque region of the trigger element 1508 may block external light from reaching an optical detector. Under these sensing conditions, the detection apparatus 1500 may generate the signal indicative of the rogue money item so that the drive apparatus 400 may halt forward movement of the conveyor tracks 500, 600, and optionally temporarily reverse movement of the tracks 500, 600, so as to reduce the possibility of jams and other operational disruption.

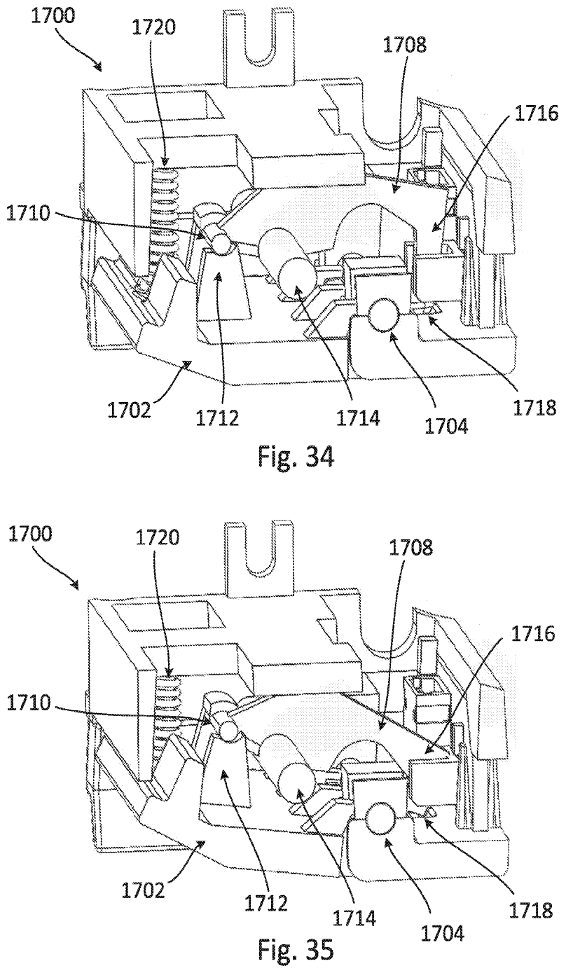

Another implementation of the money item detection apparatus is shown in FIGS. 34 and 35. This implementation has similarities with the implementation described above with respect to FIGS. 30-32. For example, referring to FIGS. 34 and 35, the detection apparatus 1700 operates using a dual-pivot action in which a money item contact element 1702 is configured to move around a first pivot 1704 and a trigger element 1708 is configured to move around a second pivot 1714. As with the pivots 1504, 1514 of the apparatus 1500 discussed with respect to FIGS. 30-32, the first and second pivots 1704, 1714 are fixedly attached to a static body of the conveying apparatus 200 or wider money item handling system 100. It can be seen that the specific shape of the contact element 1702 is different to the contact element 1502 shown in FIGS. 30-32. Whereas the element 1502 in FIGS. 30-32 comprises a curved frontal portion against which rogue money items exert forces on the element 1502, the contact element 1702 shown in FIGS. 34 and 35 comprises a planar frontal portion which is angled with respect to a different plane of a rearward portion of the element 1702.

As with both examples 1200, 1500 described previously, the coupling between the contact element 1702 and the primary pivot 1704 comprises a mechanical link so that mechanical pressure on the contact element 1702 causes the element 1702 to move around the pivot 1704. Further, a first end 1710 of the trigger element 1708 is coupled to the contact element 1702 via a coupling 1712 so that movement of the contact element 1702 relative to the primary pivot 1704 causes a corresponding movement in the trigger element 1708. In particular, movement of the contact element 1702 away from the tracks 500, 600 due to forces exerted on the contact element 1702 by one or more rogue money items causes a corresponding movement in the first end 1710 of the pivot 1708. As the first end 1710 of the trigger element 1708 moves with the contact element 1702, the trigger element 1708 as a whole is caused to move around the secondary pivot 1714 so that a second end 1716 of the trigger element 1708 moves into a region of a sensor 1718 and thereby initiates a ‘stop’ signal of the kind described previously.

First and second respective positions of the money item contact element 1702 and trigger element 1708 are shown in FIGS. 34 and 35. In FIG. 34, the contact element 1702 is in a first position which is naturally adopted when the contact element 1702 is not being physically influenced by one or more rogue money items on the tracks 500, 600. The contact element 1702 is biased towards this position by a sprung element 1720 which is configured to exert pressure on the non-track side of the element 1702, pushing the element 1702 towards the first position. In FIG. 35, on the other hand, the contact element 1702 is in a second position into which it is forced, against the action of the sprung element 1720, when one or more rogue money items on the tracks 500, 600 physically push against the contact element 1702. It can be seen from FIG. 35 that, relative to the first position shown in FIG. 34, in the second position the contact element 1702 has pivoted around the primary pivot 1704 as the frontal portion of the contact element 1702 is forced away from the tracks 500, 600. This movement has caused the trigger element 1708 to correspondingly move from its own first position, as shown in FIG. 34, to its second position shown in FIG. 35. As described above, in this second position, movement of the tracks 500, 600 is halted and optionally reversed by actuation of a switch comprising the sensor 1718.

As previously mentioned, with all of the described implementations of the money item detection apparatus 1200, 1500, 1700, rogue money items may continue to travel a certain distance along the conveyor path after initial contact with the contact element 1202, 1502, 1702. This may occur while the tracks 500, 600 of the conveyor 300 are brought to a halt. This period of residual travel of rogue money items is deliberately accommodated within the detection apparatus 1200, thereby preventing damage or significant disruption to other parts of the conveyor 300. In particular, any such residual travel of rogue money items is absorbed by the movement of the contact element 1202, 1502, 1702 relative to the primary pivot 1204, 1504, 1704.

Once primary money items 800 on the tracks 500, 600 have passed by the detection apparatus 1200, 1500 in the inclined region B of the conveyor path, the money items 800 progress into the sensing region C. In this region, the static support 700 accommodates the one or more sensors 900 already discussed. In this regard, referring to FIG. 33, the sensing region C of the conveyor 300 may also comprise one or more additional sensors 1600 which are arranged to detect money items 800 from the opposite side to the sensor(s) 900 in the support 700. The sensors 900, 1600 may operate as a group to detect physical, geometric and electromagnetic properties of the money items 800.

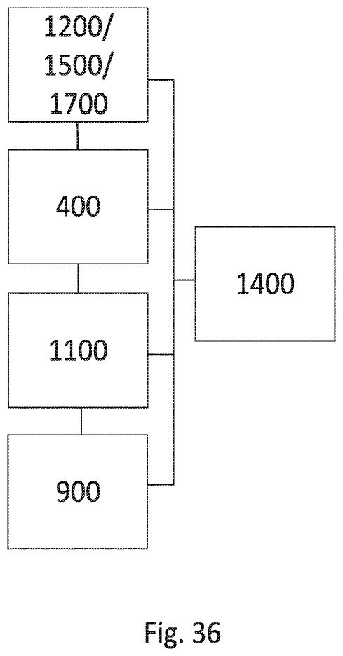

Referring to FIG. 36, operation of the money item handling system 100 including the conveying apparatus 200, drive apparatus 400, sensor(s) 900, money item detection apparatus 1200, 1500, 1700 and other powered parts of the system 100, may be controlled by the computing apparatus 1100. For example, the computing apparatus 1100 may selectively control actuation of the conveyor 300 to move money items 800 between different regions of the system 100 by causing appropriate control signals to be supplied to the drive apparatus 400 and other powered system elements such as gates which transition money items 800 to and/or from the conveyor 300.

The computing apparatus 1100 may be communicatively coupled to a power supply 1400 of the system 100. The power supply 1400 facilitates movement and control of the powered system parts discussed above as required and, for example, as instructed by the computing apparatus 1100.

The computing apparatus 1100 comprises at least one computer processor and at least one computer memory. The processor executes computer-readable instructions stored in the memory to cause the movement and functional control of the system 100, including that of the elements specifically mentioned above. For the avoidance of doubt, the computing apparatus may include a single processor or may comprise one or more architectures employing multiple processor designs for increased computing capability. The computer memory may comprise, for example, one or more read-only memories (ROMs), random access memories (RAMs), EPROMS, EEPROMs, Flash memories, magnetic or optical cards or application specific integrated circuits (ASICs). Additionally or alternatively, the computer memory may comprise any type of storage disk, such as one or more floppy disks, optical disks, CD-ROMs and/or magnetic-optical disks, or any other type of media suitable for storing electronic instructions which can be executed by the processor. The memory is coupled to the processor and other elements of the computing apparatus architecture via a computer system bus. The processor is configured to implement the instructions under the control of the computer-readable instructions to operate the system 1000.

As previously explained, primary money items 800 which are collected by the tracks 500, 600 of the conveyor 300 may be denominated and/or validated using the sensor(s) 900 in the static support 700. This means that, once a money item 800 on the conveyor 300 has passed the sensor(s) 900 at least once, its denomination and position on the conveyor tracks 500, 600 known to the system 100. Once money items 800 have passed the sensor(s) 900, the denomination and position of each money item 800 on the conveyor 300 may, for example, be stored in a memory of the system 100.

It will be appreciated that there are various modifications and adaptations that can be made to the specific aspects of the system 100 described above. The aspects described above may be used either singly or in combination. In this specification, the term “money items” refers, for example, to coins or other tokens of a monetary value.

The specification includes the following subject-matter expressed in the form of clauses 1-34.

Clause 1: A money item conveying apparatus, comprising a first track section comprising at least one first money item conveying element a second track section comprising at least one second money item conveying element and a static support section located between the first track section and the second track section, wherein the first track section and the second track section are configured to move together relative to the static support section to convey a primary money item in contact with the at least one first money item conveying element and the at least one second money item conveying element over the static support section.

Clause 2: The money item conveying apparatus of clause 1, wherein the at least one first money item conveying element and the at least one second money item conveying element are configured to stably locate the primary money item in a centre-justified position over the static support section during movement of the first and second track sections.

Clause 3: The money item conveying apparatus of clause 1 or 2, wherein the at least one first money item conveying element and the at least one second money item conveying element are configured to stably locate the primary money item in a position which at least partially overlaps the static support section, the first track section and the second track section.

Clause 4: The money item conveying apparatus of any of clauses 1-3, further comprising at least one money item sensor located at least partially within the static support section.

Clause 5: The money item conveying apparatus of clause 4, wherein the static support section comprises at least one aperture in which the at least one money item sensor is at least partially located.

Clause 6: The money item conveying apparatus of clause 4 or 5, wherein the at least one money item sensor is configured to determine physical and/or geometric characteristics of the primary money item.

Clause 7: The money item conveying apparatus of any of clauses 4-6, wherein the at least one money item sensor is configured to determine electromagnetic characteristics of the primary money item.

Clause 8: The money item conveying apparatus of any of clauses 1-7, wherein the static support section comprises a first mating region arranged to cooperate with a corresponding mating region of the first track section and wherein the static support section comprises a second mating region arranged to cooperate with a corresponding mating region of the second track section.

Clause 9: The money item conveying apparatus of any of clauses 1-8, wherein the static support section comprises a surplus money item ejection portion which is configured to direct a surplus money item away from the static support section and off the money item conveying apparatus.

Clause 10: The money item conveying apparatus of clause 9, wherein the surplus money item ejection portion comprises a recessed region of the static support section into which the surplus money item is conveyed to be directed off the money item conveying apparatus.

Clause 11: The money item conveying apparatus of clause 10, wherein the surplus money item is conveyed into the recessed region of the static support section by at least partial abutment between a rearward edge of the surplus money item and a forward edge of the primary money item as the first and second track sections move together relative to the static support section.

Clause 12: The money item conveying apparatus of any of clauses 9-11, wherein the surplus money item is located directly forward of the primary money item in a direction of movement of the first and second track sections.

Clause 13: The money item conveying apparatus of any of clauses 9-12, wherein the surplus money item ejection portion is arranged to physically interact with the surplus money item to direct the surplus money item off the conveying apparatus.

Clause 14: The money item conveying apparatus of clause 13, wherein the surplus money item ejection portion comprises an ejection element which traverses a width of the static support section at a non-perpendicular angle relative to a direction of movement of the first and second track sections.

Clause 15: The money item conveying apparatus of clause 14, wherein surplus money items are forced against the ejection element by forward movement of the first and second track sections.

Clause 16: The money item conveying apparatus of clause 15, wherein at least partial abutment between a rearward edge of the surplus money item and a forward edge of the primary money item pushes the surplus money item against the ejection element.

Clause 17: The money item conveying apparatus of any of clauses 9-16, wherein the first and second track sections are arranged to support the primary money item away from the surplus money item ejection portion of the static support.

Clause 18: The money item conveying apparatus of clause 17, wherein the first and second track sections each comprise a money item support surface for supporting a principal face of the primary money item away from the surplus money item ejection portion of the static support and a recessed surface, wherein the money item support surface and the recessed surface of each of the first and second track sections are separated by a transition ramp.

Clause 19: The money item conveying apparatus of clause 18, wherein a distance between the transition ramp of the first track section and the transition ramp of the second track section increases with increasing distance from the at least one first conveying element and the at least one second conveying element.

Clause 20: A money item detection apparatus operable in a system comprising a money item conveyor, wherein the money item detection apparatus comprises a contact region arranged to physically interact with money items in a disruption configuration on the money item conveyor and a trigger region physically connected to the contact region and moveable between first and second positions, wherein physical interaction between the contact region and a money item in a disruption configuration on the money item conveyor causes the trigger region to move from the first position to the second position to halt the money item conveyor.

Clause 21: The money item detection apparatus of clause 20, wherein the trigger region is configured to actuate a switch when moved to the second position to prevent further motion of the money item conveyor.

Clause 22: The money item detection apparatus of clause 21, wherein actuation of the switch causes a drive apparatus which is engaged with the money item conveyor to cease actuating the money item conveyor.

Clause 23: The money item detection apparatus of clause 21 or 22, wherein the switch comprises an optical link which is broken by an opaque portion of the trigger region when the trigger region moves into the second position.

Clause 24: The money item detection apparatus of any of clauses 20-23, wherein the contact region and the trigger region are coupled to a pivot.

Clause 25: The money item detection apparatus of clause 24, wherein the physical interaction between the contact region and the money item in the disruption configuration causes the trigger region to move around the pivot into the second position.

Clause 26: The money item detection apparatus of any of clauses 20-23, wherein the contact region is coupled to a first pivot and the trigger region is coupled to a second pivot.

Clause 27: The money item detection apparatus of clause 26, wherein the physical interaction between the contact region and the money item in the disruption configuration causes the contact region to move around the first pivot and the trigger region to move around the second pivot into the second position.

Clause 28: The money item detection apparatus of any of clauses 20-27, wherein the contact region comprises a contact element which extends toward the money item in the disruption configuration as the money item approaches the detection apparatus on the money item conveyor.

Clause 29: The money item detection apparatus of clause 28, wherein a leading edge of the contact element curves directly away from a principal surface of the money item conveyor to physically interact with the money item in the disruption configuration.

Clause 30: The money item detection apparatus of clause 28, wherein a leading edge of the contact element is angled directly away from a principal surface of the money item conveyor to physically interact with the money item in the disruption configuration.

Clause 31: The money item detection apparatus of any of clauses 28-30, wherein a conveyor-side of the contact element comprises at least one channel for accommodating an upstanding element of the money item conveyor as the upstanding element passes the contact element.

Clause 32: The money item detection apparatus of any of clauses 20-31, wherein the money item in the disruption configuration is at least partially balanced on an upstanding element of the money item conveyor.

Clause 33: The money item detection apparatus of any of clauses 20-32, wherein the trigger region naturally adopts the first position when not physically interacting with the money item in the disruption configuration.

Clause 34: A system comprising the money item conveying apparatus of any of clauses 1-19 and the money item detection apparatus of any of clauses 20-33.

1. A money item detection apparatus operable in a system comprising a money item conveyor, wherein the money item detection apparatus comprises:
a contact region arranged to physically interact with money items in a disruption configuration on the money item conveyor; and
a trigger region physically connected to the contact region and moveable between first and second positions,
wherein physical interaction between the contact region and a money item in the disruption configuration on the money item conveyor causes the trigger region to move from the first position to the second position to halt the money item conveyor.

2. The money item detection apparatus of claim 1, wherein the trigger region is configured to actuate a switch when moved to the second position to prevent further motion of the money item conveyor.

3. The money item detection apparatus of claim 2, wherein actuation of the switch causes a drive apparatus which is engaged with the money item conveyor to cease actuating the money item conveyor.

4. The money item detection apparatus of claim 2, wherein the switch comprises an optical link which is broken by an opaque portion of the trigger region when the trigger region moves into the second position.

5. The money item detection apparatus of claim 1, wherein the contact region and the trigger region are coupled to a pivot.

6. The money item detection apparatus of claim 5, wherein the physical interaction between the contact region and the money item in the disruption configuration causes the trigger region to move around the pivot into the second position.

7. The money item detection apparatus of claim 1, wherein the contact region is coupled to a first pivot and the trigger region is coupled to a second pivot.

8. The money item detection apparatus of claim 7, wherein the physical interaction between the contact region and the money item in the disruption configuration causes the contact region to move around the first pivot and the trigger region to move around the second pivot into the second position.

9. The money item detection apparatus of claim 1, wherein the contact region comprises a contact element which extends toward the money item in the disruption configuration as the money item approaches the detection apparatus on the money item conveyor.

10. The money item detection apparatus of claim 9, wherein a leading edge of the contact element curves directly away from a principal surface of the money item conveyor to physically interact with the money item in the disruption configuration.

11. The money item detection apparatus of claim 9, wherein a leading edge of the contact element is angled directly away from a principal surface of the money item conveyor to physically interact with the money item in the disruption configuration.

12. The money item detection apparatus of claim 9, wherein a conveyor-side of the contact element comprises at least one channel for accommodating an upstanding element of the money item conveyor as the upstanding element passes the contact element.

13. The money item detection apparatus of claim 1, wherein the money item in the disruption configuration is at least partially balanced on an upstanding element of the money item conveyor.

14. The money item detection apparatus of claim 1, wherein the trigger region naturally adopts the first position when not physically interacting with the money item in the disruption configuration.

15. A system comprising:
a money item conveyor; and
a money item detection apparatus comprising:
a contact region arranged to physically interact with money items in a disruption configuration on the money item conveyor; and
a trigger region physically connected to the contact region and moveable between first and second positions,
wherein physical interaction between the contact region and a money item in the disruption configuration on the money item conveyor causes the trigger region to move from the first position to the second position to halt the money item conveyor.

16. The system of claim 15, wherein the trigger region is configured to actuate a switch when moved to the second position to prevent further motion of the money item conveyor.

17. The system of claim 16, wherein actuation of the switch causes a drive apparatus which is engaged with the money item conveyor to cease actuating the money item conveyor.

18. The system of claim 16, wherein the switch comprises an optical link which is broken by an opaque portion of the trigger region when the trigger region moves into the second position.

19. The system of claim 15, wherein the contact region and the trigger region are coupled to a pivot.

20. The system of claim 19, wherein the physical interaction between the contact region and the money item in the disruption configuration causes the trigger region to move around the pivot into the second position.
